(19) United States
(12) Patent Application Publication
(10) Pub. No.: US 2018/0365340 A1
(43) Pub. Date: Dec. 20, 2018

(54) NON-TRANSITORY COMPUTER-READABLE STORAGE MEDIUM, EXTRACTION METHOD AND EXTRACTION DEVICE

(71) Applicant: FUJITSU LIMITED, Kawasaki-shi (JP)

(72) Inventors: Yuichi TOMIO, Meguro (JP); Hideyuki MIURA, Urayasu (JP); Naoya TAKAHASHI, Yokohama (JP); Ryuichi KAWASAKI, Kawasaki (JP); Yugo SHOTANI, Yokohama (JP)

(73) Assignee: FUJITSU LIMITED, Kawasaki-shi (JP)

(21) Appl. No.: 16/009,981

(22) Filed: Jun. 15, 2018

(30) Foreign Application Priority Data
Jun. 19, 2017 (JP) 2017-119271

(51) Int. Cl. G06F 17/30

(52) U.S. Cl. CPC G06F 17/30988

(57) ABSTRACT

A non-transitory computer-readable storage medium storing a program that causes a computer to execute a process, the process including obtaining reference counts that are numbers of times respective pieces of content were referred to, classifying the pieces of content into a plurality of groups based on the reference counts, selecting one or more feature phrases from each of the pieces of content based on appearance frequencies of words included in each of the pieces of content, and extracting first content that includes a feature phrase which is included in all of the plurality of groups, wherein the feature phrase is any one of the one or more features selected by the selecting.

### CROSS-REFERENCE TO RELATED APPLICATION

This application is based upon and claims the benefit of priority of the prior Japanese Patent Application No. 2017-119271, filed on Jun. 19, 2017, the entire contents of which are incorporated herein by reference.

### FIELD

The embodiment discussed herein is related to a non-transitory computer-readable storage medium, an extraction method, and an extraction device.

### BACKGROUND

Although various types of content are made publicly available on web sites, and for example, those pieces of content include content, such as information regarding obsolete technologies, that is not viewed by users. It is desired that such content that is not viewed be deleted during maintenance of the web sites. For example, an example in which moving average values of the numbers of accesses are calculated based on an access log for the content and whether or not usefulness of the content is continuing is determined based on transition of the moving average values has been proposed as a content evaluation method. Also, there has been proposed a technology for extracting main content from web documents and extracting well-known or popular keywords from the extracted main content.

Related technologies are disclosed in Japanese Laid-open Patent Publication No. 2011-154487 and Japanese Laid-open Patent Publication No. 2010-204866.

### SUMMARY

According to an aspect of the invention, a non-transitory computer-readable storage medium storing a program that causes a computer to execute a process, the process including obtaining reference counts that are numbers of times respective pieces of content were referred to, classifying the pieces of content into a plurality of groups based on the reference counts, selecting one or more feature phrases from each of the pieces of content based on appearance frequencies of words included in each of the pieces of content, and extracting first content that includes a feature phrase which is included in all of the plurality of groups, wherein the feature phrase is any one of the one or more features selected by the selecting.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the configuration of an extraction system in an embodiment;

FIG. 2 illustrates an example of the keyphrase storage section;

FIG. 3 is a table illustrating an example of the undefined-keyphrase storage section;

FIG. 4 is a table illustrating an example of the user-dictionary storage section;

FIG. 5 is a table illustrating an example of the deletion-candidate storage section;

FIG. 6 is a table illustrating an example of the condition storage section;

FIG. 7 is a diagram illustrating an example of a relationship between to-be-evaluated content and keyphrase extraction sources;

FIG. 8 illustrates an example of extracting keyphrases;

FIG. 9 illustrates an example of update of deletion conditions;

FIGS. 10A and 10B are flowcharts illustrating an example of extraction processing in the embodiment;

FIG. 11 is a flowchart illustrating an example of the undefined keyphrase processing;

FIG. 12 is a flowchart illustrating an example of the deletion processing;

FIG. 13 is a flowchart illustrating an example of the update processing;

FIG. 14 illustrates an example of pieces of content;

FIG. 15 illustrates an example of extraction and classification of the keyphrases when a piece of content is evaluated;

FIG. 16 illustrates an example of extraction and classification of keyphrases when another piece of content is evaluated;

FIG. 17 illustrates an example of extraction and classification of keyphrases when another piece of content is evaluated;

FIG. 18 illustrates an example of extraction and classification of keyphrases when another piece of content is evaluated;

FIG. 19 illustrates an example of extraction and classification of keyphrases when another piece of content is evaluated;

FIG. 20 illustrates an example of extraction and classification of keyphrases when another piece of content is evaluated;

FIG. 21 illustrates an example of extraction and classification of keyphrases when another piece of content is evaluated;

FIG. 22 illustrates an example of evaluation results of the content; and

FIG. 23 is a block diagram illustrating an example of a computer that executes an extraction program.

### DESCRIPTION OF EMBODIMENT

There are cases in which, during deletion of content that is not viewed, for example, when content to which the number of accesses is small is simply selected as content to be deleted, content that is likely to be referred to in the future is deleted although the number of accesses thereto is small. Thus, it is desired that content that is likely to be referred to in the future be extracted in advance so that the content is not to be deleted. However, it takes large amounts of time and effort for an administrator of a web site to extract each piece of content while checking it, which is difficult.

An object of one aspect is to provide an extraction program, an extraction method, and an extraction device that make it possible to extract content that is likely to be referred to in the future, even if the number of references (which may be referred to hereinafter as a “reference count”) to the content is small.

An extraction program, an extraction method, and an extraction device according to an embodiment disclosed herein will be described below in detail with reference to the accompanying drawings. The present embodiment is not intended to limit the disclosed technology. What is disclosed in the embodiment described below may appropriately be combined as long as such a combination does not cause contradiction.

### Embodiment

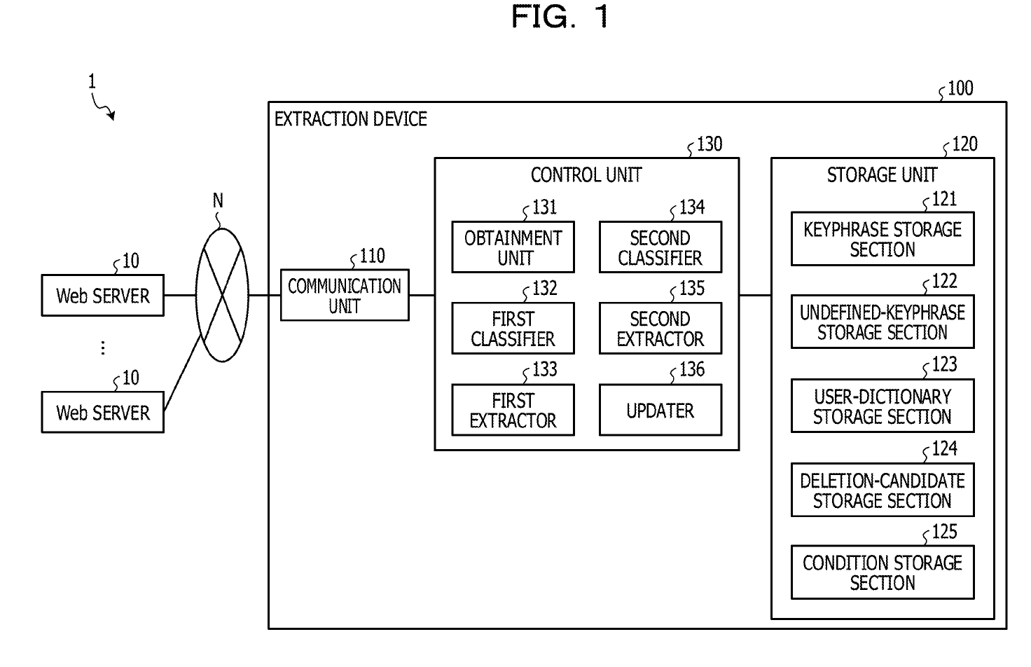

FIG. 1 is a block diagram illustrating an example of the configuration of an extraction system in an embodiment. An extraction system 1 illustrated in FIG. 1 includes web servers 10 and an extraction device 100. The number of web servers 10 is not limiting, and the extraction system 1 may include any number of web servers 10. The web servers 10 and the extraction device 100 are communicably connected to each other through a network N. The network N may be implemented by any type of communication network, such as the Internet, a local area network (LAN), or a virtual private network (VPN), regardless of whether it is wired or wireless.

Each web server 10 is, for example, an information processing apparatus for operating a web site (also referred to hereinafter as a “site”) for providing information about a group of products to customers, service personnel, and so on. Each web server 10 has pieces of content in the site. Examples of the pieces of content include web pages written in the HyperText Markup Language (HTML). Also, an access log including the numbers of accesses (which are also referred to hereinafter as “reference counts”), access dates and times, and so on for the respective pieces of content are recorded in each web server 10. Based on deletion information received from the extraction device 100, each web server 10 also deletes the content corresponding to the deletion information. Although an example in which one web server 10 provides one site will be described in the present embodiment, the present disclosure is not limited thereto, and one web server 10 may provide a plurality of sites.

The extraction device 100 obtains the reference counts for the respective pieces of content from each web server 10 through the network N, each reference count being the number of times each piece of content was referred to. Based on the reference counts, the extraction device 100 classifies the pieces of content into a plurality of groups. The extraction device 100 extracts main phrases in the content from each of the groups, the main phrases being based on appearance frequencies of words included in the content. The extraction device 100 extracts the content including a main phrase that appears in all of the groups. Thus, the extraction device 100 can extract content that is likely to be referred to in the future, even if the reference count of the content is small.

The configuration of the extraction device 100 will be described next. As illustrated in FIG. 1, the extraction device 100 includes a communication unit 110, a storage unit 120, and a control unit 130. The extraction device 100 may also have various functional units included in a known computer, other than the functional units illustrated in FIG. 1. Examples of such functional units include various types of input device, sound output device, and so on.

The communication unit 110 is implemented by, for example, a network interface card (NIC) or the like. The communication unit 110 serves as a communication interface that is connected to the web servers 10 through the network N in a wired or wireless manner and is responsible for communicating information with the web servers 10. The communication unit 110 outputs the access log, received from each web server 10, to the control unit 130. The communication unit 110 also transmits deletion information, input from the control unit 130, to the corresponding web server 10.

The storage unit 120 is implemented by, for example, a semiconductor memory device, such as a random-access memory (RAM) or a flash memory, or a storage device for a hard disk, an optical disk, or the like. The storage unit 120 includes a keyphrase storage section 121, an undefined-keyphrase storage section 122, a user-dictionary storage section 123, a deletion-candidate storage section 124, and a condition storage section 125. Information used for processing in the control unit 130 is stored in the storage unit 120.

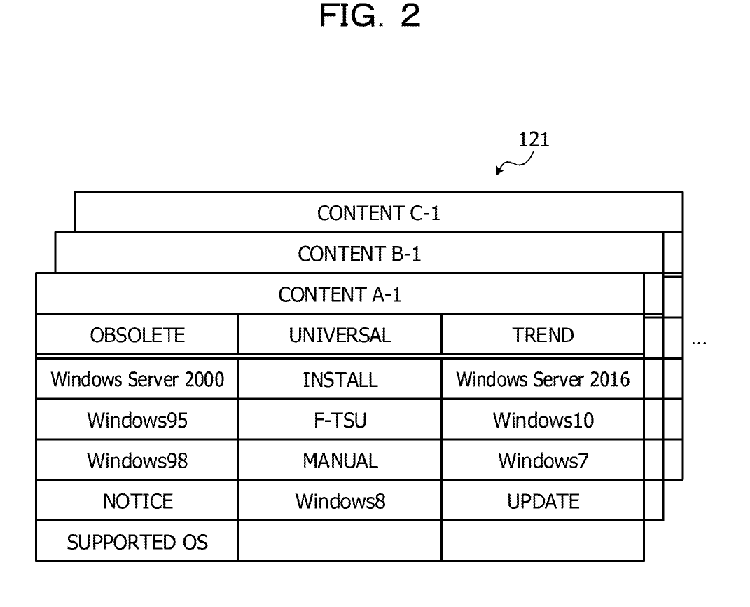

Keyphrases extracted from keyphrase extraction source content are classified according to appearance frequencies of the keyphrases in the content and are stored in the keyphrase storage section 121. Each keyphrase is a main phrase in the content and includes a keyword. Each keyphrase is made of, for example, words comprising only nouns, a phrase including a plurality of nouns, or a phrase comprising a combination of an adjective and a noun. FIG. 2 illustrates an example of the keyphrase storage section 121. As illustrated in FIG. 2, the keyphrase storage section 121 has entries for “obsolete”, “universal”, “trend” for classifying keyphrases, extracted from keyphrase extraction source content, according to the appearance frequencies of the keyphrases for each piece of content to be evaluated.

The “obsolete” is information indicating, of the keyphrases extracted from each of the pieces of content classified into the two groups according to the numbers of accesses, a keyphrase that appears in the group in which the number of accesses is small. The “universal” is information indicating, of the keyphrases extracted from each of the pieces of content classified into the two groups according to the numbers of accesses, a keyphrase that appears in both of the groups. The “trend” is information indicating, of the keyphrases extracted from each of the pieces of content classified into the two groups according to the numbers of accesses, a keyphrase that appears in the group in which the number of accesses is large.

In the example of content A-1 in FIG. 2, keyphrases classified into the “obsolete” are “Windows® Server 2000”, “Windows 95”, “Windows 98”, “notice”, and “supported OS”. Also, keyphrases classified into the “universal” are “install”, “F-tsu”, “manual”, and “Windows 8”. Keyphrases classified into the “trend” are “Windows Server 2016”, “Windows 10”, “Windows 7”, and “update”. In the following description, keyphrases classified into the “obsolete”, “universal”, and “trend” may be referred to as “obsolete keyphrases”, “universal keyphrases”, and “trend keyphrase”, respectively.

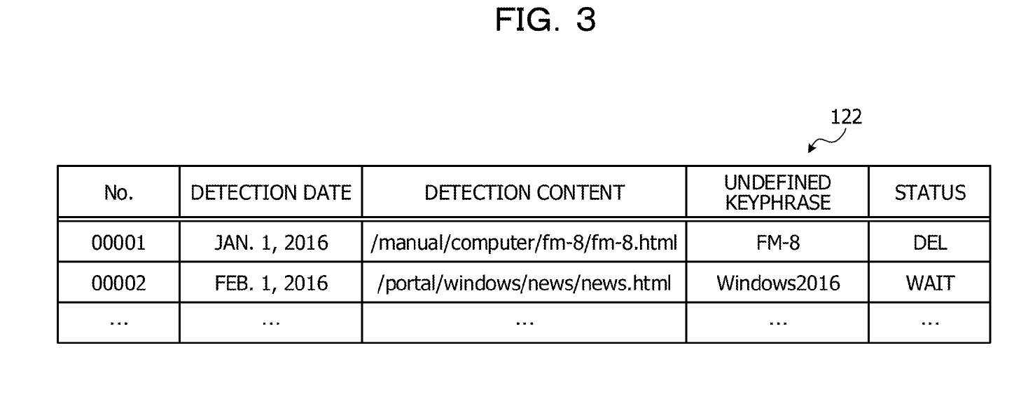

Referring to FIG. 1, of the keyphrases extracted from content to be evaluated (hereinafter referred to as “to-be-evaluated content”), keyphrases that are not classified into any of the “obsolete”, “universal”, and “trend” and that do not exist in a user dictionary are stored in the undefined-keyphrase storage section 122. FIG. 3 is a table illustrating an example of the undefined-keyphrase storage section 122. As illustrated in FIG. 3, the undefined-keyphrase storage section 122 has entries for “No.”, “detection date”, “detection content”, “undefined keyphrase”, and “status”. For example, the entries corresponding to each undefined keyphrase are stored in the undefined-keyphrase storage section 122 as one record.

The “No.” is an identifier for identifying an undefined keyphrase. The “detection date” is information indicating a date when the undefined keyphrase is detected for the first time during evaluation of to-be-evaluated content. The “detection content” is information indicating content from which the undefined keyphrase was detected. The “undefined keyphrase” is information indicating a keyphrase that is included in keyphrases extracted from to-be-evaluated content, that is not classified into any of the “obsolete”, “universal, and “trend”, and that does not exist in a user dictionary. The “status” is information indicating a status of the undefined keyphrase. In the “status”, for example, “WAIT” indicates an on-hold state, and “DEL” indicates a state in which the content including the corresponding undefined keyphrase was deleted. The example in the first row illustrated in FIG. 3 indicates that an undefined keyphrase “FM-8” was detected from content “/manual/computer/fm-8/fm-8.html” on “Jan. 1, 2016”, and this content has already been deleted.

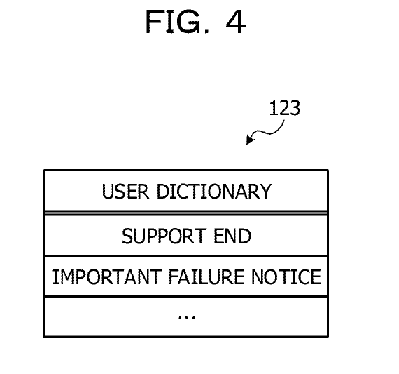

Referring back to FIG. 1, keyphrases for excluding to-be-evaluated content from content to be deleted are stored in the user-dictionary storage section 123 as a user dictionary. FIG. 4 is a table illustrating an example of the user-dictionary storage section 123. As illustrated in FIG. 4, the user-dictionary storage section 123 has entries for “user dictionary”. Although keyphrases included in content that is desired to be excluded from content to be deleted are pre-stored in the “user dictionary” to/from a keyphrase can be added/deleted. In the example illustrated in FIG. 4, keyphrases “support end”, “important failure notice”, and so on are registered.

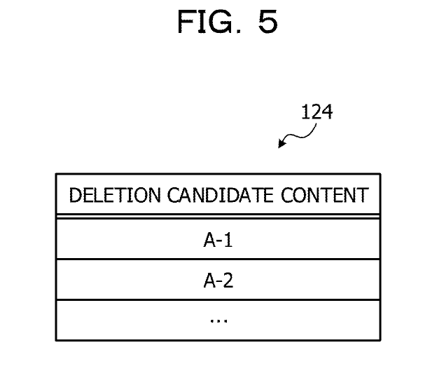

Referring back to FIG. 1, to-be-evaluated content that satisfies the deletion conditions are stored in the deletion-candidate storage section 124 as deletion candidate content, based on an evaluation result of the to-be-evaluated content. FIG. 5 is a table illustrating an example of the deletion-candidate storage section 124. As illustrated in FIG. 5, the deletion-candidate storage section 124 has entries for “deletion candidate content”. The identifier of to-be-evaluated content that satisfies the deletion conditions is stored in the “deletion candidate content”. In the example illustrated in FIG. 5, the pieces of content A-1 and A-2 are set as deletion candidate content.

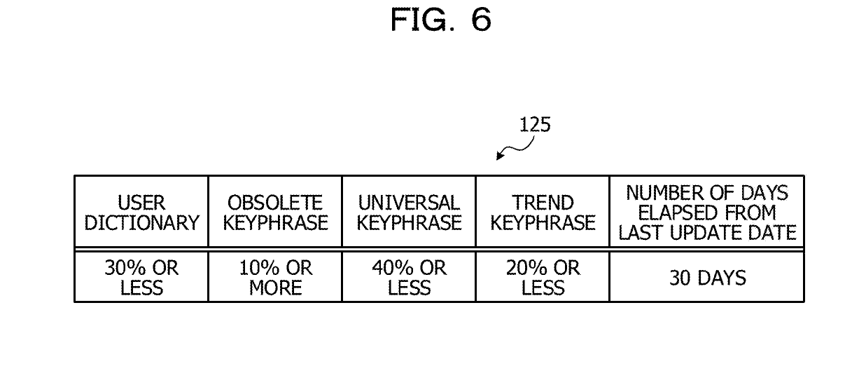

Referring back to FIG. 1, the deletion conditions for determining that to-be-evaluated content is deletion candidate content and a condition regarding update of the to-be-evaluated content are stored in the condition storage section 125. FIG. 6 is a table illustrating an example of the condition storage section 125. As illustrated in FIG. 6, the condition storage section 125 has entries for “user dictionary”, “obsolete keyphrase”, “universal keyphrase”, “trend keyphrase”, and “number of days elapsed from last update date”. The deletion conditions are the “user dictionary”, “obsolete keyphrase”, “universal keyphrase”, and “trend keyphrase”. Also, the condition regarding the update is the “number of days elapsed from last update date”.

The “user dictionary” is information indicating a threshold for an appearance rate of keyphrases registered in the user dictionary relative to all keyphrases in the to-be-evaluated content. The appearance rate of keyphrases is a keyphrase appearance frequency expressed in percentage. The “obsolete keyphrase” is information indicating a threshold for the appearance rate of obsolete keyphrases relative to all keyphrases in the to-be-evaluated content. The “universal keyphrase” is information indicating a threshold for the appearance rate of universal keyphrases relative to all keyphrases in the to-be-evaluated content. The “trend keyphrase” is information indicating a threshold for the appearance rate of trend keyphrases relative to all keyphrases in the to-be-evaluated content. The “number of days elapsed from last update date” is information indicating a threshold for the number of days elapsed from the last update date of the to-be-evaluated content. The “number of days elapsed from last update date” may be, for example, 30 days.

For example, a central processing unit (CPU) or a micro processing unit (MPU) executes a program stored in an internal storage device by using a random-access memory (RAM) as a work area, to thereby realize the control unit 130. The control unit 130 may also be realized by, for example, an integrated circuit, such as an application-specific integrated circuit (ASIC) or a field programmable gate array (FPGA).

The control unit 130 includes an obtainment unit 131, a first classifier 132, a first extractor 133, a second classifier 134, a second extractor 135, and an updater 136 and realizes or executes functions and effects of information processing described below. That is, the processing units in the control unit 130 execute extraction processing. The extraction processing is executed, for example, at predetermined intervals, such as every month, every three months, every half a year, or every year. The internal configuration of the control unit 130 is not limited to the configuration illustrated in FIG. 1 and may be another configuration as long as it is a configuration for performing information processing described below.

For example, when an administrator of the web server 10 gives an instruction for evaluating pieces of content in a site by using a terminal apparatus (not illustrated), the obtainment unit 131 sets to-be-evaluated content and keyphrase extraction source content (which may be referred to hereinafter as “extraction source content”). The obtainment unit 131 obtains the to-be-evaluated content and the extraction source content from the corresponding web server 10 via the communication unit 110 and the network N. Also, the obtainment unit 131 obtains an access log of the set extraction source content from the corresponding web server 10 via the communication unit 110 and the network N. That is, the obtainment unit 131 obtains reference counts, which are the numbers of times the respective pieces of content were referred to. The obtainment unit 131 outputs the obtained extraction source content and the obtained access log of the extraction source content to the first classifier 132. The obtainment unit 131 also outputs the obtained to-be-evaluated content to the first extractor 133.

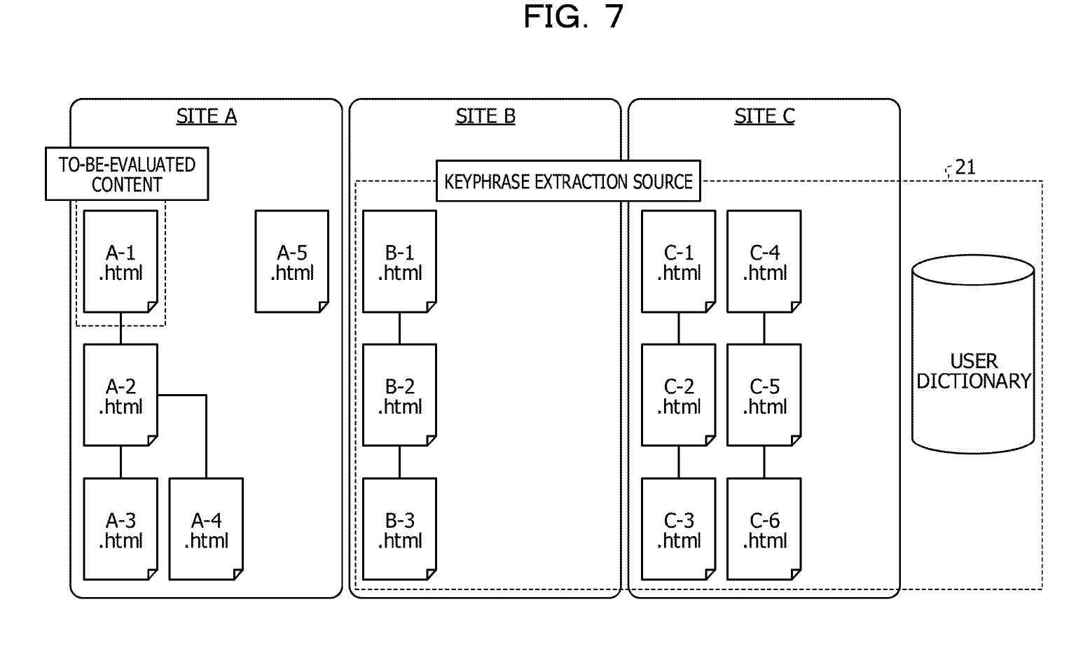

Now, a relationship between to-be-evaluated content and keyphrase extraction sources will be described with reference to FIG. 7. FIG. 7 is a diagram illustrating an example of a relationship between to-be-evaluated content and keyphrase extraction sources. In the example illustrated in FIG. 7, site A is a site where information about a certain product group is provided to customers. Also, in the example illustrated in FIG. 7, sites B are C are sites where information about groups of products is provided for in-house use in a company for providing products for service personnel, sales personnel, system engineers, and so on. In such a case, in the example illustrated in FIG. 7, in order to maintain the information in site A, which is a site for customers, pieces of content in sites B and C, which are sites for in-house use, are utilized as keyphrase extraction sources in conjunction with the user dictionary.

In the example illustrated in FIG. 7, when “A-1.html” in site A is set as to-be-evaluated content, content and the user dictionary included in a keyphrase extraction source 21 are keyphrase extraction sources. That is, the obtainment unit 131 obtains “A-1.html” in site A as to-be-evaluated content. The obtainment unit 131 also obtains “B-1.html” to “B-3.html” in site B and “C-1.html” to “C-6.html” in site C as keyphrase extraction source content. The obtainment unit 131 also obtains an access log for the keyphrase extraction source content that is obtained. When evaluation of “A-1.html” is completed, the extraction device 100 sequentially evaluates the remaining content in site A and determines content to be deleted. In other words, the extraction device 100 extracts content that is not to be deleted.

Also, by not designating a site including to-be-evaluated content as a keyphrase extraction source, the obtainment unit 131 can perform more objective evaluation. That is, since it is thought that similar keyphrases are highly likely to scatter in the content in the site, extracting keyphrases from content in other sites and evaluating the extracted keyphrases makes it possible to perform more objective evaluation.

Referring back to FIG. 1, the extraction source content obtained from the obtainment unit 131 and the access log of the extraction source content are input to the first classifier 132. Based on the obtained access log, the first classifier 132 classifies the extraction source content into a first group and a second group. That is, the first classifier 132 classifies the extraction source content into a first group in which the reference count in the access log is small and a second group in which the reference count in the access log is large. The first classifier 132 outputs the extraction source content to the first extractor 133 in conjunction with classification information regarding the classified groups.

That is, based on the reference counts, the first classifier 132 classifies pieces of content into a plurality of groups. The first classifier 132 also classifies pieces of content (extraction source content) different from the to-be-evaluated content into a plurality of groups.

Upon input of the extraction source content and the classification information from the first classifier 132, the first extractor 133 extracts keyphrases for each of the classified group. That is, the first extractor 133 extracts keyphrases for each of the first and second groups. That is, the first extractor 133 extracts main phrases (keyphrases) in the content from each of the groups, the keyphrases being based on the appearance frequencies of words included in the content. The first extractor 133 outputs the extracted keyphrases for each of the groups to the second classifier 134.

Upon input of the to-be-evaluated content from the obtainment unit 131, the first extractor 133 extracts keyphrases from the to-be-evaluated content. The first extractor 133 outputs the extracted keyphrases of the to-be-evaluated content to the second classifier 134. The first extractor 133 also refers to a timestamp of the to-be-evaluated content to obtain the last update date and time of the to-be-evaluated content. The first extractor 133 outputs the obtained last update date and time to the second extractor 135. The timestamp of the to-be-evaluated content is, for example, information indicating creation date and time, last update date and time, or the like held in a file system of an operating system (OS).

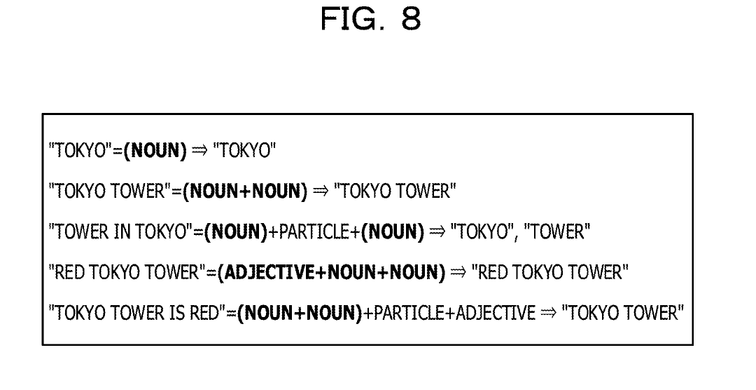

Now, extraction of keyphrases will be described with reference to FIG. 8. FIG. 8 illustrates an example of extracting keyphrases. As illustrated in FIG. 8, the targets of keyphrases are nouns, and continuous nouns and a noun with an adjective are respectively treated as single keyphrases. Also, words coupled to each other by a particle are treated as individual phrases. The minimum unit of a keyphrase is one noun. In the example illustrated in FIG. 8, since “Tokyo” is a noun, the keyphrase is “Tokyo”. Since “Tokyo Tower” comprises two continuous nouns, the keyphrase is “Tokyo Tower”. Since “tower in Tokyo” is a combination of a noun, a particle, and a noun, it has two keyphrases “Tokyo” and “tower”. Since “red Tokyo Tower” has two continuous nouns with an adjective, the keyphrase is “red Tokyo Tower”. Since an adjective plays the role of modifying a noun to limit a designated subject, the adjective forms one keyphrase in conjunction with the noun. Since “Tokyo Tower is red” is a combination of two continuous nouns, a particle, and an adjective, the keyphrase is “Tokyo Tower”.

Referring back to FIG. 1, upon input of keyphrases for each group from the first extractor 133, the second classifier 134 classifies the keyphrases into obsolete keyphrases, universal keyphrases, and trend keyphrases. The second classifier 134 classifies keyphrases that appear in only the first group into the obsolete keyphrase, that is, first main phrases. The second classifier 134 also classifies keyphrases that appear in both of the first and second groups into the universal keyphrases, that is, second main phrases. The second classifier 134 also classifies keyphrases that appear in only the second group into the trend keyphrase, that is, third main phrases. The second classifier 134 stores the classified keyphrases in the keyphrase storage section 121.

That is, the second classifier 134 classifies the main phrases extracted from each of the groups into the first main phrases that appear in only the first group, the second main phrases that appear in both of the first and second groups, and the third main phrases that appear in only the second group.

Upon input of keyphrases of the to-be-evaluated content from the first extractor 133, the second classifier 134 refers to the keyphrase storage section 121 and the user-dictionary storage section 123 to classify the input keyphrases. That is, the second classifier 134 classifies the keyphrases extracted from the to-be-evaluated content into the user dictionary keyphrases, the obsolete keyphrases, the universal keyphrases, the trend keyphrases, and the undefined keyphrases.

The second classifier 134 classifies a keyphrase included in the keyphrases extracted from the to-be-evaluated content and registered in the user dictionary into the user dictionary keyphrases. The second classifier 134 classifies a keyphrase that is included in the keyphrases extracted from the to-be-evaluated content and that matches a keyphrase in the “obsolete” field in the keyphrase storage section 121 into the obsolete keyphrases. The second classifier 134 classifies a keyphrase that is included in the keyphrases extracted from the to-be-evaluated content and that matches a keyphrase in the “universal” field in the keyphrase storage section 121 into the universal keyphrases. The second classifier 134 classifies a keyphrase that is included in the keyphrases extracted from the to-be-evaluated content and that matches a keyphrase in the “trend” field in the keyphrase storage section 121 into the trend keyphrases. The second classifier 134 classifies a keyphrase that is included in the keyphrases extracted from the to-be-evaluated content and that has not been classified into any of the user dictionary keyphrases, the obsolete keyphrases, the universal keyphrases, and the trend keyphrases into the undefined keyphrases.

That is, since undefined keyphrases are keyphrases that do not exist in the keyphrase extraction source content and the user dictionary, it is difficult to directly use the undefined keyphrases for evaluation. Accordingly, based on whether or not a classified undefined keyphrase was also classified into the undefined keyphrases during past evaluation of to-be-evaluated content, the second classifier 134 executes undefined keyphrase processing for determining whether the classified undefined keyphrase is an obsolete keyphrase or a trend keyphrase.

The second classifier 134 determines whether or not an undefined keyphrase exists in the classified keyphrases. When an undefined keyphrase does not exist, the second classifier 134 ends the undefined keyphrase processing. When an undefined keyphrase exists, the second classifier 134 refers to the undefined-keyphrase storage section 122 to check whether or not each undefined keyphrase has appeared in the past.

When the checked undefined keyphrase has appeared in the past, the second classifier 134 classifies the undefined keyphrase into the obsolete keyphrases. When the checked undefined keyphrase has not appeared in the past, the second classifier 134 stores the undefined keyphrase in the undefined-keyphrase storage section 122. When the processing based on whether or not there is an occurrence in the past is completed for all of the undefined keyphrases, the second classifier 134 ends the undefined keyphrase processing. Upon completing the undefined keyphrase processing, the second classifier 134 outputs the classified keyphrases of the to-be-evaluated content to the second extractor 135.

That is, when the checked undefined keyphrase has appeared in the past, the undefined keyphrase is a keyphrase that has not been used in other sites (sites B and C), which are evaluation references, from a past evaluation time to the present time, and thus the second classifier 134 classifies the undefined keyphrase into the obsolete keyphrases. That is, the undefined keyphrase is a keyphrase that was not used (added) in the keyphrase extraction source content. In contrast, when the undefined keyphrase is a keyphrase classified into the trend keyphrases, the undefined keyphrase is highly likely to be added in other sites, and in this case, the unknown keyphrase is classified into the trend keyphrases. That is, when the checked undefined keyphrase has not appeared in the past, the undefined keyphrase is a keyphrase that does not exist in the other sites (sites B and C), which are evaluation references, and thus, the undefined keyphrase is thought to be considerably obsolete or trendy. Thus, the second classifier 134 puts the undefined keyphrase on hold until next evaluation in order to check a future trend and stores the undefined keyphrase in the undefined-keyphrase storage section 122.

In other words, the second classifier 134 stores, in the undefined-keyphrase storage section 122, a fourth main phrase (an undefined keyphrase) that is included in main phrases extracted from to-be-evaluated content and that is a main phrase not corresponding to any of the first main phrases, the second main phrases, and the third main phrases. During next content extraction, when a fourth main phrase extracted from the to-be-evaluated content matches any of the fourth main phrases stored in the undefined-keyphrase storage section 122, the second classifier 134 classifies the extracted fourth main phrase into the first main phrases (obsolete keyphrases).

Now, a description will be given of transition from when what is stored in the undefined-keyphrase storage section 122 changes from an empty state to the state of the undefined-keyphrase storage section 122 illustrated in FIG. 3. First, a keyphrase “FM-8” extracted from content “/manual/computer/fm-8/fm-8.html” is classified into the undefined keyphrases. As a result, identifier “00001”, detection date “Jan. 1, 2016”, detection content “/manual/computer/fm-8/fm-8.html”, the undefined keyphrase “FM-8”, and status “WAIT” are stored in the undefined-keyphrase storage section 122. This is a state in which the status in the first row in FIG. 3 is “WAIT”. Next, when content “/portal/windows/news/news.html” including “Windows 2016” that corresponds to “trend” appears for the first time, the extracted keyphrase “Windows 2016” is classified into the undefined keyphrases. As a result, identifier “00002”, detection date “Feb. 1, 2016”, detection content “/portal/windows/news/news.html”, the undefined keyphrase “Windows 2016”, and status “WAIT” are stored in the undefined-keyphrase storage section 122 (that is, the state in the second row in FIG. 3).

Subsequently, when other content including the undefined keyphrase “FM-8” does not appear during next scanning, the undefined keyphrase “FM-8” is classified into the obsolete keyphrases. However, for example, when a user dictionary keyphrase is included in the content “/manual/computer/fm-8/fm-8.html”, and the content does not become content to be deleted, the contents of the undefined-keyphrase storage section 122 do not change. On the other hand, when the content becomes content to be deleted, the status for the undefined keyphrase “FM-8” in the undefined-keyphrase storage section 122 is updated from “WAIT” to “DEL” (that is, the state in the first row in FIG. 3). As a result, what is stored in the undefined-keyphrase storage section 122 is changed from an empty state to the state of the undefined-keyphrase storage section 122 illustrated in FIG. 3.

When other content including the undefined keyphrase “Windows 2016” appears during next scanning, the undefined keyphrase is stored in the keyphrase storage section 121 as a trend keyphrase. In this case, although the record of the undefined keyphrase “Windows 2016” in the undefined-keyphrase storage section 122 is deleted, the record may be kept unchanged and then be deleted during maintenance. The maintenance is performed, for example, when the number of records becomes enormous, and a record in which the status is “DEL” and a record in which the status is “WAIT” and a predetermined number of days (for example, 365 days) has passed may be deleted.

When each classified keyphrase of the to-be-evaluated content is input from the second classifier 134, the second extractor 135 evaluates the to-be-evaluated content. That is, based on the classified keyphrases of the to-be-evaluated content, the second extractor 135 calculates appearance frequencies, that is, appearance rates, of the keyphrases in the to-be-evaluated content for respective classifications of the keyphrases. Specifically, the second extractor 135 calculates an appearance rate of user dictionary keyphrases, an appearance rate of obsolete keyphrases, an appearance rate of universal keyphrases, and an appearance rate of trend keyphrases of all keyphrases extracted from the to-be-evaluated content.

By referring to the condition storage section 125, the second extractor 135 determines whether or not the to-be-evaluated content satisfies the deletion conditions, based on the calculated appearance rates of the classified keyphrases. When the to-be-evaluated content does not satisfy the deletion conditions, the second extractor 135 extracts the to-be-evaluated content as content to be maintained. The second extractor 135 generates update information including trend keyphrases of the to-be-evaluated content and outputs the update information to the updater 136.

When the to-be-evaluated content satisfies the deletion conditions, the second extractor 135 sets the to-be-evaluated content as deletion candidate content and stores the identifier of the set set deletion candidate content in the deletion-candidate storage section 124.

Subsequently, the second extractor 135 executes deletion processing. The second extractor 135 determines whether or not a predetermined number of days has elapsed from the last update date, based on the last update date and time of the to-be-evaluated content input from the first extractor 133 and a condition regarding update of the condition storage section 125. That is, the predetermined number of days is the number of days in the “number of days elapsed from last update date” field in the condition storage section 125.

Upon determining that the predetermined number of days has elapsed from the last update date, the second extractor 135 refers to the deletion-candidate storage section 124 to generate deletion information based on the identifier of the deletion candidate content. The second extractor 135 transmits the generated deletion information to the corresponding web server 10 via the communication unit 110 and the network N. Upon transmitting the deletion information, the second extractor 135 generates update information for updating the deletion conditions and the user dictionary and outputs the update information to the updater 136. The update information includes, for example, the calculated appearance rates of the respective classified keyphrases and obsolete keyphrases included in the content for which the deletion information was transmitted.

Upon determining that the predetermined number of days has not passed from the last update date, the second extractor 135 deletes, from the deletion-candidate storage section 124, the identifier of the deletion candidate content to be determined and releases the setting of the deletion candidate content. The second extractor 135 outputs, to the updater 136, the update information including the trend keyphrases of the to-be-evaluated content for which the setting for the deletion candidate content was released.

The second extractor 135 determines whether or not un-evaluated content exists in a site to which the to-be-evaluated content belongs. Upon determining that un-evaluated content exists in the site to which the to-be-evaluated content belongs, the second extractor 135 designates next to-be-evaluated content and outputs, to the obtainment unit 131, an instruction for obtaining the designated to-be-evaluated content from the corresponding web server 10.

Upon determining that un-evaluated content does not exist in the site to which the to-be-evaluated content belongs, the second extractor 135 outputs, to the updater 136, an update instruction for executing processing for updating the deletion conditions and the user dictionary.

In other words, the second extractor 135 extracts content including a main phrase that appears in all of the groups. Also, when the to-be-evaluated content includes a main phrase that appears in all of the groups, the second extractor 135 extracts the to-be-evaluated content. Also, the second extractor 135 extracts content, based on the appearance frequencies of the first main phrases (obsolete keyphrases), the second main phrases (universal keyphrases), and the third main phrases (trend keyphrases). Also, by referring to the user-dictionary storage section 123 in which pre-set fifth main phrases (user dictionary keyphrase) are stored, the second extractor 135 extracts content, based on the appearance frequencies of the first main phrases, the second main phrases, the third main phrases, and the fifth main phrases. The second extractor 135 also issues, to a source (the web server 10) from which the reference counts of the pieces of content were obtained, an instruction for deleting the to-be-evaluated content that is included in to-be-evaluated content not extracted and that satisfies a predetermined condition.

The update information for each piece of to-be-evaluated content is input to the updater 136 from the second extractor 135. Upon input of the update instruction from the second extractor 135, the updater 136 executes update processing. Based on the input update information of the to-be-evaluated content, the updater 136 determines whether or not there is deleted content.

Upon determining that there is deleted content, the updater 136 updates the deletion conditions in the condition storage section 125 and the user dictionary in the user-dictionary storage section 123, based on the update information. That is, the updater 136 updates the deletion conditions in the condition storage section 125, based on the appearance rates of the respective classified keyphrases included in the update information for the content for which the deletion information was transmitted. The updater 136 also deletes, from the user-dictionary storage section 123, a keyphrase that matches an obsolete keyphrase included in the content for which the deletion information was transmitted.

Upon determining that there is no deleted content, the updater 136 updates the user dictionary in the user-dictionary storage section 123, based on the update information. That is, the updater 136 adds, to the user-dictionary storage section 123, trend keyphrases included in the update information for the to-be-evaluated content extracted as being content to be maintained. Upon completing the processing on all the input update information, the updater 136 ends the update processing.

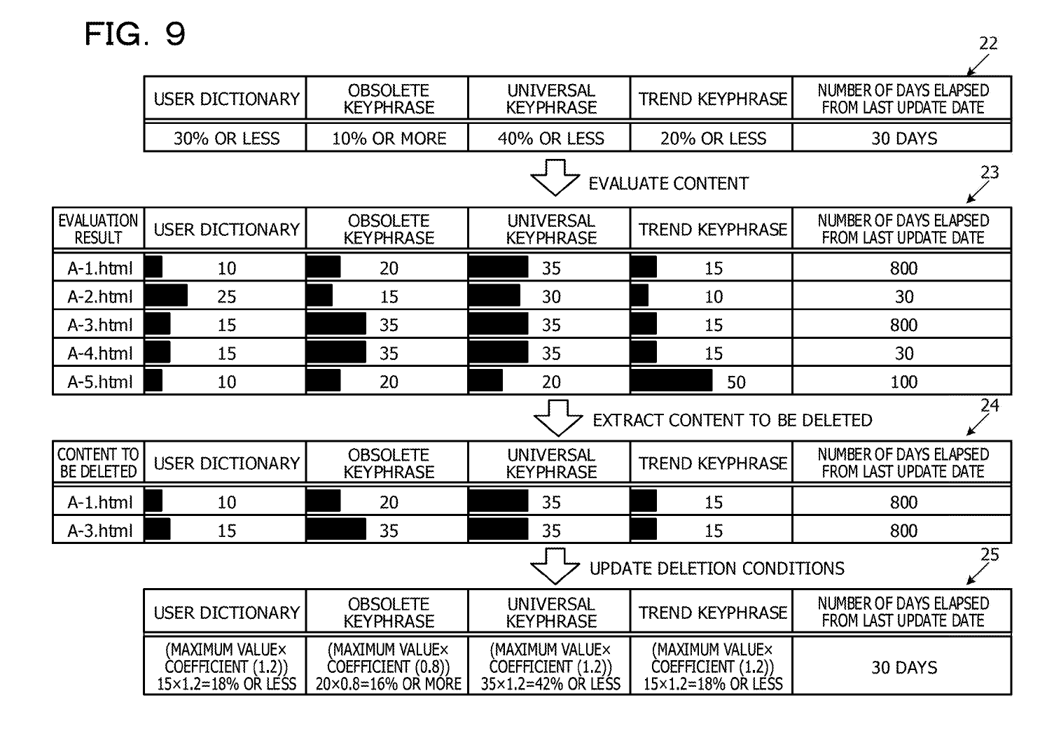

Now, update of the deletion conditions will be described with reference to FIG. 9. FIG. 9 illustrates an example of update of deletion conditions. A table 22 illustrated in FIG. 9 illustrates, for example, deletion conditions and an update-related condition stored in the condition storage section 125 as initial values. Based on the deletion conditions and the update-related condition stored in Table 22, the extraction device 100 evaluates content. The deletion conditions and the update-related condition in Table 22 state that, for example, the user dictionary is “30% or less”, the obsolete keyphrases are “10% or more”, the universal keyphrases are “40% or less”, the trend keyphrases are “20% or less”, and the number of days elapsed from the last update date is “30 days”.

Table 23 illustrates evaluation results of, for example, five pieces of content “A-1.html” to “A-5.html” in site A. The extraction device 100 extracts content to be deleted, by comparing the evaluation results in Table 23 with the deletion conditions and the update-related condition in Table 22. Table 24 illustrates extracted pieces of content to be deleted, and “A-1.html” and “A-3.html” are pieces of content to be deleted.

The updater 136 updates the deletion conditions and the update-related condition in Table 22, based on the entries in Table 24. With respect to “user dictionary” in the deletion conditions, the updater 136 determines, as a new deletion condition, for example, a value obtained by multiplying the maximum value of appearance rates in the pieces of content to be deleted by a predetermined coefficient (for example, 1.2). In the example illustrated in FIG. 9, a new deletion condition “18% or less” is determined by multiplying “15”% for “A-3.html” by the coefficient “1.2”. With respect to “obsolete keyphrase” in the deletion conditions, the updater 136 determines, as a new deletion condition, for example, a value obtained by multiplying the minimum value of appearance rates in the pieces of content to be deleted by a predetermined coefficient (for example, 0.8). In the example illustrated in FIG. 9, a new deletion condition “16% or more” is determined by multiplying “20”% in “A-1.html” by the coefficient “0.8”.

With respect to “universal keyphrase” in the deletion conditions, the updater 136 determines, as a new deletion condition, for example, a value obtained by multiplying the maximum value of appearance rates in the pieces of content to be deleted by a predetermined coefficient (for example, 1.2). In the example illustrated in FIG. 9, a new deletion condition “42% or less” is determined by multiplying “35”% in “A-1.html” by the coefficient “1.2”. With respect to “trend keyphrase” in the deletion conditions, the updater 136 determines, as a new deletion condition, for example, a value obtained by multiplying the maximum value of appearance rates in the pieces of content to be deleted by a predetermined coefficient (for example, 1.2). In the example illustrated in FIG. 9, a new deletion condition “18% or less” is determined by multiplying “15”% in “A-1.html” by the coefficient “1.2”. No update is made on the “number of days elapsed from last update date”, which is an update-related condition. Table 25 illustrates a summary of the equations for update, deletion conditions after the update, and the update-related condition.

In other words, the updater 136 updates the appearance frequency setting values for extracting content, based on the appearance frequencies of the first main phrases, the second main phrases, the third main phrases, and the fifth main phrases in content that is included in pieces of content and that was not extracted. Also, when a first main phrase included in content that was not extracted is stored in the user-dictionary storage section 123 in which the fifth main phrases are stored, the updater 136 deletes the fifth main phrase that matches the first main phrase from the user-dictionary storage section 123 in which the fifth main phrases are stored. The updater 136 also stores a third main phrase (a trend keyphrase), included in the extracted content, in the user-dictionary storage section 123 in which the fifth main phrases are stored as a fifth main phrase (a user dictionary keyphrase) to be added.

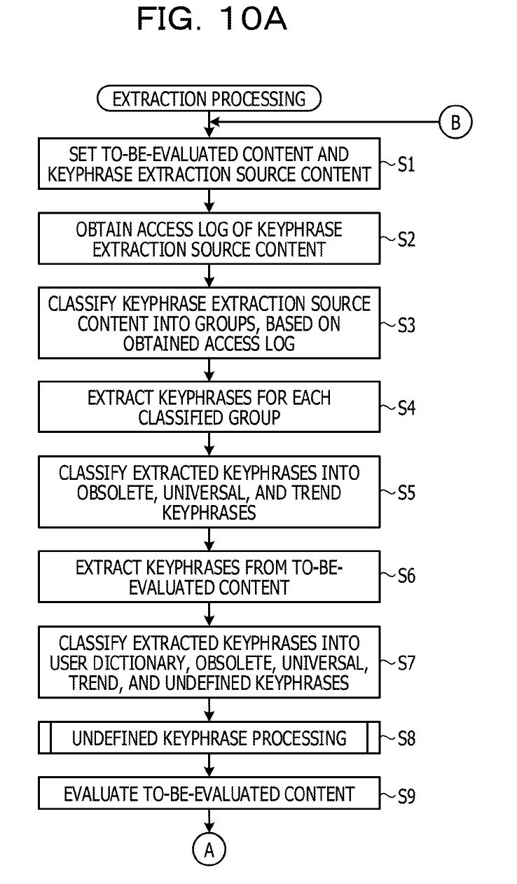

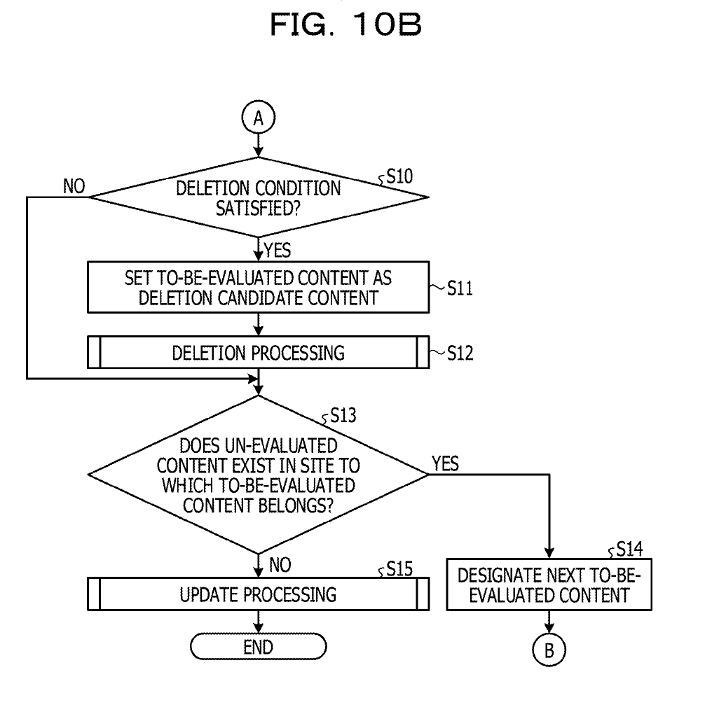

Next, a description will be given of the operation of the extraction device 100 in the embodiment. FIGS. 10A and 10B are flowcharts illustrating an example of extraction processing in the embodiment.

For example, when an administrator of the web server 10 gives an instruction for evaluating each piece of content, the obtainment unit 131 in the extraction device 100 sets to-be-evaluated content and keyphrase extraction source content (step S1). The obtainment unit 131 obtains the to-be-evaluated content and the extraction source content from the corresponding web server 10. The obtainment unit 131 also obtains an access log of the set extraction source content from the corresponding web server 10 (step S2). The obtainment unit 131 outputs the obtained extraction source content and the obtained access log of the extraction source content to the first classifier 132. The obtainment unit 131 also outputs the obtained to-be-evaluated content to the first extractor 133.

Based on the obtained access log, the first classifier 132 classifies the keyphrase extraction source content into the first group and the second group (step S3). The first classifier 132 outputs the extraction source content to the first extractor 133 in conjunction with classification information regarding the classified groups.

Upon input of the extraction source content and the classification information from the first classifier 132, the first extractor 133 extracts keyphrases for each of the classified groups (step S4). The first extractor 133 outputs the extracted keyphrases for each of the groups to the second classifier 134.

Upon input of the keyphrases for each of the groups from the first extractor 133, the second classifier 134 classifies the keyphrases into obsolete keyphrases, universal keyphrases, and trend keyphrases (step S5). The second classifier 134 stores the classified keyphrases in the keyphrase storage section 121.

Upon input of the to-be-evaluated content from the obtainment unit 131, the first extractor 133 extracts keyphrases from the to-be-evaluated content (step S6). The first extractor 133 outputs the extracted keyphrases of the to-be-evaluated content to the second classifier 134. The first extractor 133 also refers to a timestamp of the to-be-evaluated content to obtain the last update date and time of the to-be-evaluated content. The first extractor 133 outputs the obtained last update date and time to the second extractor 135.

Upon input of the keyphrases of the to-be-evaluated content from the first extractor 133, the second classifier 134 refers to the keyphrase storage section 121 and the user-dictionary storage section 123 to classify the input keyphrases. That is, the second classifier 134 classifies the keyphrases extracted from the to-be-evaluated content into user dictionary keyphrases, obsolete keyphrases, universal keyphrases, trend keyphrases, and undefined keyphrases (step S7).

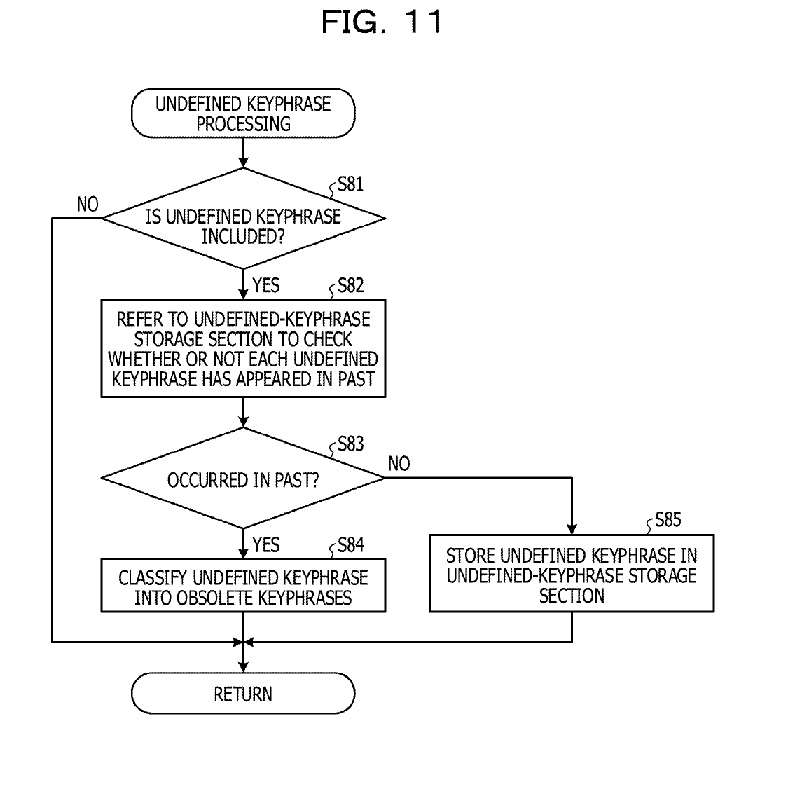

The second classifier 134 executes undefined keyphrase processing (step S8). Now, the undefined keyphrase processing will be described with reference to FIG. 11. FIG. 11 is a flowchart illustrating an example of the undefined keyphrase processing.

The second classifier 134 determines whether or not an undefined keyphrase is included in the classified keyphrases (step S81). When an undefined keyphrase is not included (Negative in step S81), the second classifier 134 ends the undefined keyphrase processing and returns to the original processing. When an undefined keyphrase exists (Affirmative in step S81), the second classifier 134 refers to the undefined-keyphrase storage section 122 to check whether or not each undefined keyphrase has appeared in the past (step S82).

The second classifier 134 determines whether or not the checked undefined keyphrase has occurred in the past (step S83). When the checked undefined keyphrase has occurred in the past (Affirmative in step S83), the second classifier 134 classifies the undefined keyphrase into the obsolete keyphrases (step S84). When the checked undefined keyphrase has not occurred in the past (Negative in step S83), the second classifier 134 stores the undefined keyphrase in the undefined-keyphrase storage section 122 (step S85). When the processing based on whether or not there is an occurrence in the past is completed for all of the undefined keyphrases, the second classifier 134 ends the undefined keyphrase processing, and the process returns to the original processing. Thus, the second classifier 134 can suppress continuously classifying an undefined keyphrase into the undefined keyphrases.

Referring to FIG. 10A, when the undefined keyphrase processing is ended, the second classifier 134 outputs the classified keyphrases of the to-be-evaluated content to the second extractor 135.

Upon input of the classified keyphrases of the to-be-evaluated content from the second classifier 134, the second extractor 135 evaluates the to-be-evaluated content (step S9). That is, the second extractor 135 calculates the appearance rate of user dictionary keyphrases, the appearance rate of obsolete keyphrases, the appearance rate of universal keyphrases, and the appearance rate of trend keyphrases of all the keyphrases extracted from the to-be-evaluated content.

By referring to the condition storage section 125, the second extractor 135 determines whether or not the to-be-evaluated content satisfies the deletion conditions, based on the calculated appearance rates of the respective classified keyphrases (step S10). When the to-be-evaluated content does not satisfy the deletion conditions (Negative in step S10), the second extractor 135 extracts the to-be-evaluated content as being content to be maintained. The second extractor 135 also generates update information including the trend keyphrases of the to-be-evaluated content and outputs the update information to the updater 136. Thereafter, the process proceeds to step S13.

When the to-be-evaluated content satisfies the deletion conditions (Affirmative in step S10), the second extractor 135 sets the to-be-evaluated content as deletion candidate content (step S11) and stores the identifier of the set deletion candidate content in the deletion-candidate storage section 124.

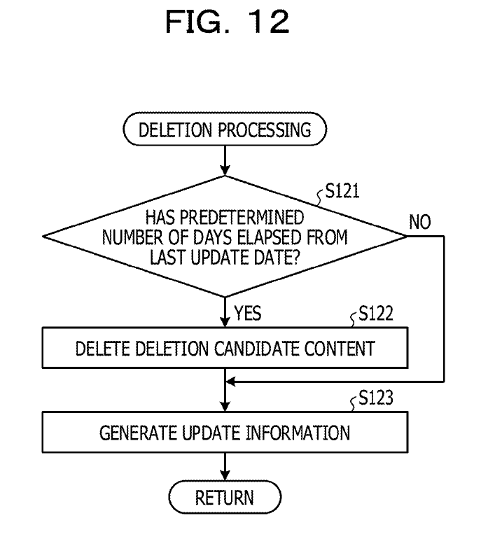

The second extractor 135 executes deletion processing (step S12). Now, the deletion processing will be described with reference to FIG. 12. FIG. 12 is a flowchart illustrating an example of the deletion processing.

Based on the last update date and time of the to-be-evaluated content input from the first extractor 133 and the update-related condition in the condition storage section 125, the second extractor 135 determines whether or not a predetermined number of days has elapsed from the last update date (step S121). Upon determining that the predetermined number of days has passed from the last update date (Affirmative in step S121), the second extractor 135 refers to the deletion-candidate storage section 124 to generate deletion information based on the identifier of the deletion candidate content. The second extractor 135 transmits the generated deletion information to the corresponding web server 10 to cause the deletion candidate content to be deleted (step S122). Thereafter, the process proceeds to step S123.

Upon determining that the predetermined number of days has not passed from the last update date (Negative in step S121), the second extractor 135 deletes the identifier of the deletion candidate content to be determined from the deletion-candidate storage section 124 and releases the setting of the deletion candidate content. Thereafter, the process proceeds to step S123.

Upon transmitting the deletion information, the second extractor 135 generates update information for updating the deletion conditions and the user dictionary and outputs the update information to the updater 136. Also, upon releasing the setting of the deletion candidate content, the second extractor 135 generates update information including the trend keyphrases of the to-be-evaluated content for which the setting of the deletion candidate content was released and outputs the update information to the updater 136 (step S123). Upon outputting the update information to the updater 136, the second extractor 135 ends the deletion processing, and then the process returns to the original processing. Thus, the second extractor 135 can control deletion of the deletion candidate content in accordance with the number of days elapsed from the last update date.

Referring back to FIG. 10B, the second extractor 135 determines whether or not un-evaluated content exists in a site to which the to-be-evaluated content belongs (step S13). Upon determining that un-evaluated content exists (Affirmative in step S13), the second extractor 135 designates next to-be-evaluated content (step S14). The second extractor 135 outputs, to the obtainment unit 131, an instruction for obtaining the designated to-be-evaluated content from the corresponding web server 10, and the process returns to step S1. Upon determining that un-evaluated content does not exist (Negative in step S13), the second extractor 135 outputs an update instruction to the updater 136.

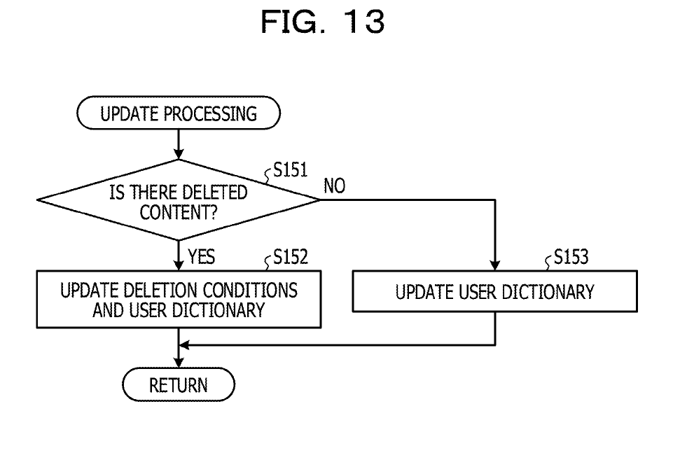

Upon input of the update instruction from the second extractor 135, the updater 136 executes update processing (step S15). Now, the update processing will be described with reference to FIG. 13. FIG. 13 is a flowchart illustrating an example of the update processing.

Based on the update information of to-be-evaluated content, the updater 136 determines whether or not there is deleted content (step S151). Upon determining that there is deleted content (Affirmative in step S151), the updater 136 updates the deletion conditions in the condition storage section 125 and the user dictionary in the user-dictionary storage section 123, based on the update information (step S152).

Upon determining that there is no deleted content (Negative in step S151), the updater 136 updates the user dictionary in the user-dictionary storage section 123, based on the update information (step S153). Upon completing the processing on all the input update information, the updater 136 ends the update processing, and the process returns to the original processing. Thus, the updater 136 can update the deletion conditions and the user dictionary in accordance with whether or not there is deleted content.

Referring to FIG. 10B, when the updater 136 ends the update processing, the extraction device 100 ends the extraction processing. Thus, the extraction device 100 can extract content that is likely to be referred to in the future, even if the reference count of the content is small. The extraction device 100 can also reduce the amount of search load during search for content that is likely to be referred to in the future.

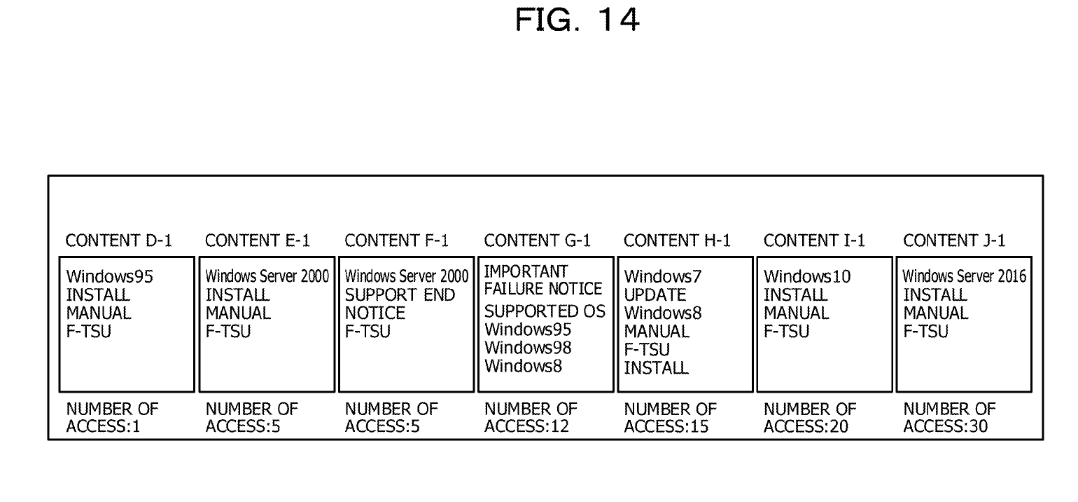

Next, a specific example in which pieces of content are evaluated and content to be maintained is extracted will be described with reference to FIGS. 14 to 22.

FIG. 14 illustrates an example of pieces of content. In the example illustrated in FIG. 14, a description will be given assuming that seven sites D to J have respective pieces of content D-1 to J-1. Keyphrases extracted from the pieces of content, instead of the content itself, are listed in FIG. 14. Also, in FIG. 14, the numbers of accesses to the pieces of content D-1 to J-1 are illustrated below the corresponding keyphrases. Each number of accesses is the number of accesses from the last evaluation time.

The extraction device 100 first sets content D-1 as to-be-evaluated content and sets the pieces of content E-1 to J-1 as keyphrase extraction source content. The extraction device 100 obtains the to-be-evaluated content D-1 and the extraction source content E-1 to J-1 from the corresponding web server 10. The extraction device 100 also obtains an access log (including the numbers of accesses) of the set extraction source content E-1 to J-1 from the web server 10.

Based on the numbers of accesses, the extraction device 100 classifies the pieces of content E-1 to G-1 into the first group in which the number of accesses is small. The extraction device 100 also classifies the pieces of content H-1 to J-1 into the second group in which the number of accesses is large. The extraction device 100 extracts keyphrases for each of the first group and the second group.

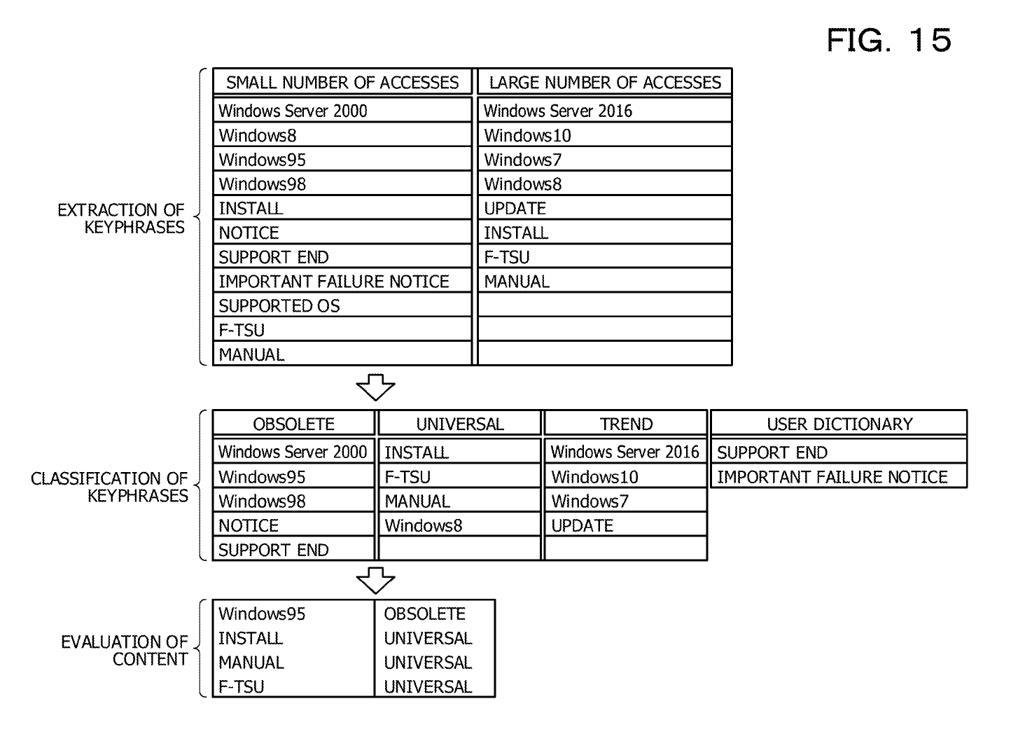

FIG. 15 illustrates an example of extraction and classification of the keyphrases when the content D-1 is evaluated. FIG. 15 illustrates the keyphrases classified into the group (the first group) in which the number of accesses is small and the group (the second group) in which the number of accesses is large when the content D-1 is evaluated.

The extraction device 100 classifies the keyphrases in the first group and the second group into obsolete keyphrases, universal keyphrases, and trend keyphrases. In FIGS. 15 to 21, keyphrases registered in the user dictionary are also illustrated in conjunction with the keyphrases illustrated in FIG. 14. The extraction device 100 classifies each keyphrase extracted from the content D-1, which is to-be-evaluated content, into one of the user dictionary keyphrases, the obsolete keyphrases, the universal keyphrases, the trend keyphrases, and the undefined keyphrases. That is, the extraction device 100 evaluates the content. In the example illustrated in FIG. 15, “Windows 95” is classified into the obsolete keyphrases, and “install”, “manual”, and “F-tsu” are classified into the universal keyphrases.

Next, the extraction device 100 sets the content E-1 as to-be-evaluated content and sets the pieces of content D-1 and F-1 to J-1 as keyphrase extraction source content. The content and the access log may be obtained as in the case of the content D-1, or the content and the access log obtained in the case of the content D-1 may be used, and a description of how the content and the access log are obtained is omitted in the description of the pieces of content F-1 to J-1.

The extraction device 100 classifies the pieces of content D-1, F-1, and G-1 into the first group (in which the number of accesses is small). The extraction device 100 classifies the pieces of content H-1 to J-1 into the second group (in which the number of accesses is large). The extraction device 100 extracts keyphrases for each of the first group and the second group.

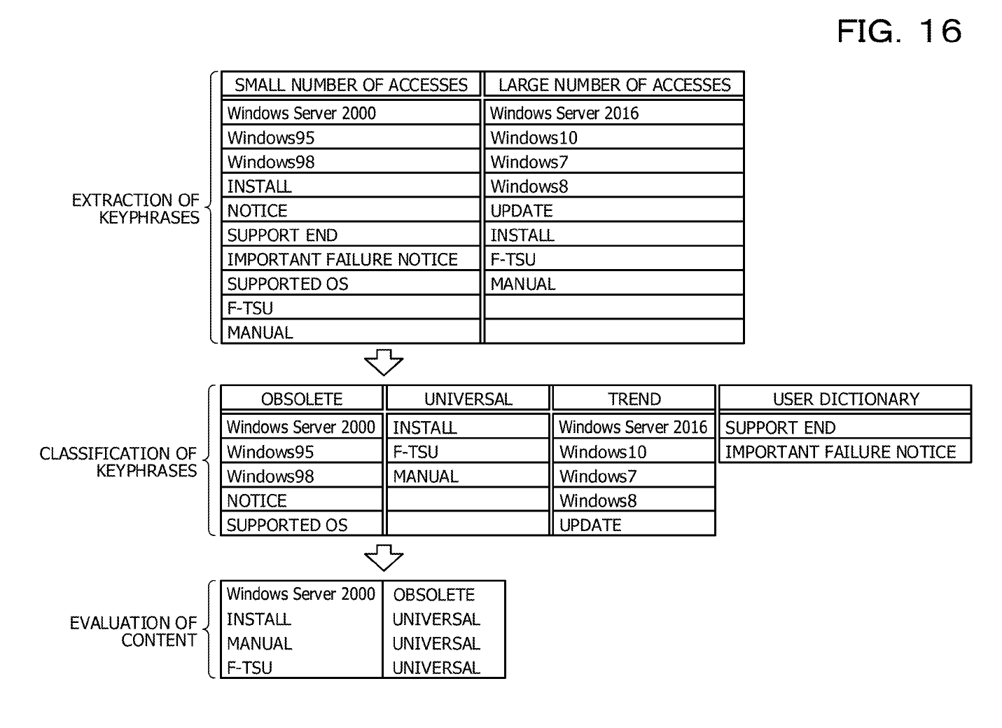

FIG. 16 illustrates an example of extraction and classification of keyphrases when the content E-1 is evaluated. FIG. 16 illustrates keyphrases classified into the group (the first group) in which the number of accesses is small and the group (the second group) in which the number of accesses is large when the content E-1 is evaluated.

The extraction device 100 classifies the keyphrases in the first group and the second group into the obsolete keyphrases, the universal keyphrases, and the trend keyphrases. The extraction device 100 classifies each keyphrase extracted from the content E-1, which is to-be-evaluated content, into one of the user dictionary keyphrases, the obsolete keyphrases, the universal keyphrases, the trend keyphrases, and the undefined keyphrases. That is, the extraction device 100 evaluates the content. In the example illustrated in FIG. 16, “Windows Server 2000” is classified into the obsolete keyphrases, and “install”, “manual”, and “F-tsu” are classified into the universal keyphrases.

Next, the extraction device 100 sets the content F-1 as to-be-evaluated content and sets the pieces of content D-1, E-1, and G-1 to J-1 as keyphrase extraction source content.

The extraction device 100 classifies the pieces of content D-1, E-1, and G-1 into the first group (in which the number of accesses is small). The extraction device 100 classifies the pieces of content H-1 to J-1 into the second group (in which the number of accesses is large). The extraction device 100 extracts keyphrases for each of the first group and the second group.

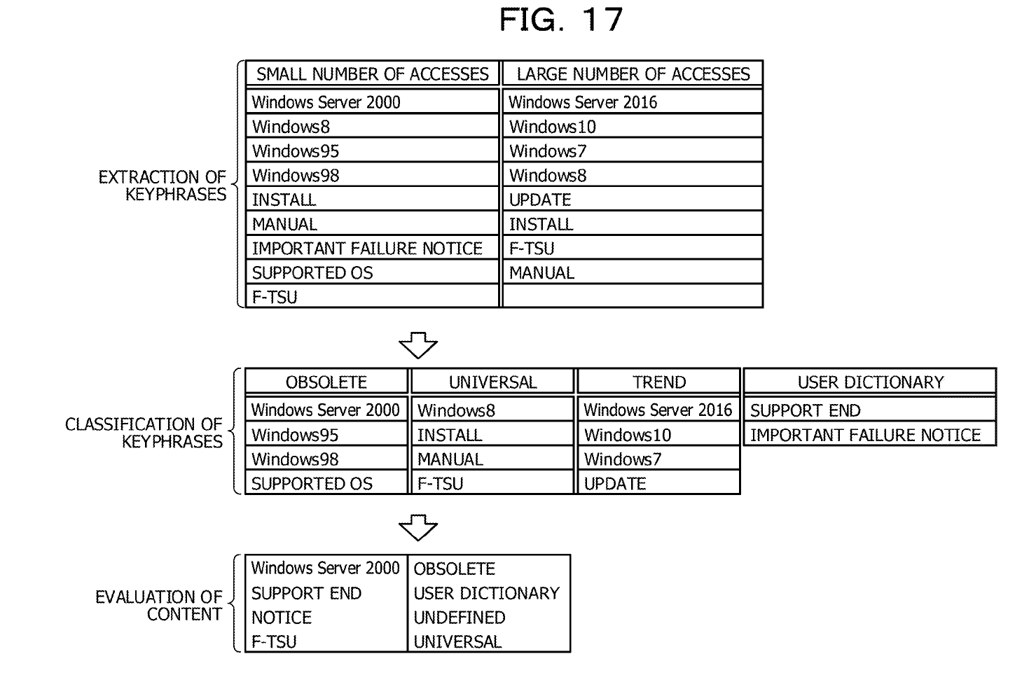

FIG. 17 illustrates an example of extraction and classification of keyphrases when the content F-1 is evaluated. FIG. 17 illustrates keyphrases classified into the group (the first group) in which the number of accesses is small and the group (the second group) in which the number of accesses is large when the content F-1 is evaluated.

The extraction device 100 classifies the keyphrases in the first group and the second group into the obsolete keyphrases, the universal keyphrases, and the trend keyphrases. The extraction device 100 classifies each keyphrase extracted from the content F-1, which is to-be-evaluated content, into one of the user dictionary keyphrases, the obsolete keyphrases, the universal keyphrases, the trend keyphrases, and the undefined keyphrases. That is, the extraction device 100 evaluates the content. In the example illustrated in FIG. 17, “Windows Server 2000” is classified into the obsolete keyphrases, “support end” is classified into the user dictionary keyphrases, “notice” is classified into the undefined keyphrases, and “F-tsu” is classified into the universal keyphrases.

Next, the extraction device 100 sets the content G-1 as to-be-evaluated content and sets the pieces of content D-1 to F-1 and H-1 to J-1 as keyphrase extraction source content.

The extraction device 100 classifies the pieces of content D-1 to F-1 into the first group (in which the number of accesses is small). Also, the extraction device 100 classifies the pieces of content H-1 to J-1 into the second group (in which the number of accesses is large). The extraction device 100 extracts keyphrases for each of the first group and the second group.

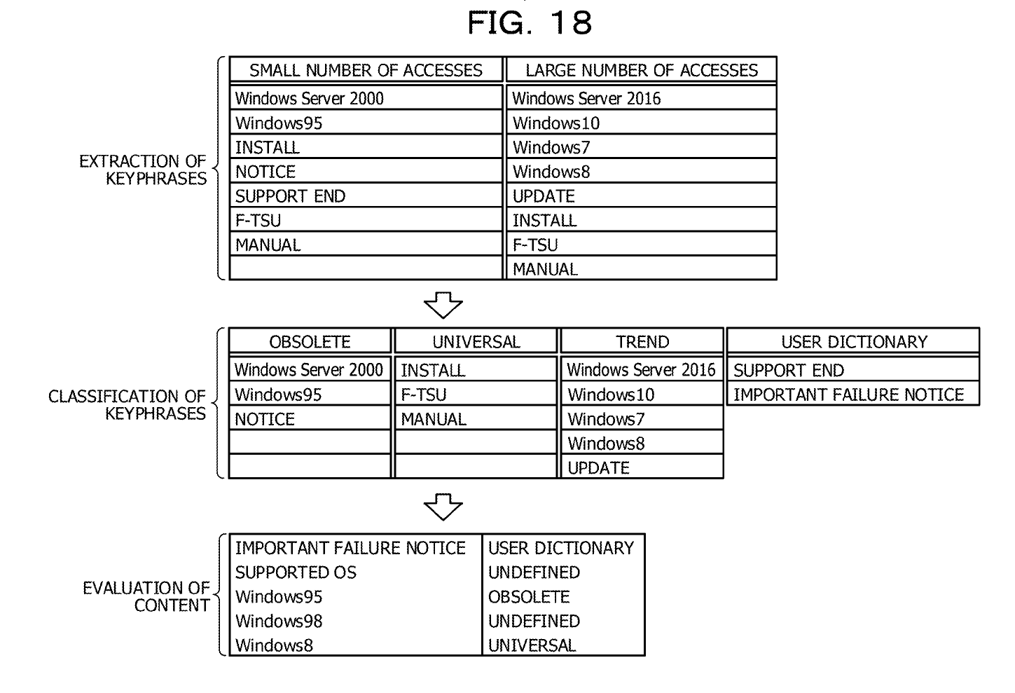

FIG. 18 illustrates an example of extraction and classification of keyphrases when the content G-1 is evaluated. FIG. 18 illustrates keyphrases classified into the group (the first group) in which the number of accesses is small and the group (the second group) in which the number of accesses is large when the content G-1 is evaluated.

The extraction device 100 classifies the keyphrases in the first group and the second group into the obsolete keyphrases, the universal keyphrases, and the trend keyphrases. The extraction device 100 classifies each keyphrase extracted from the content G-1, which is to-be-evaluated content, into one of the user dictionary keyphrases, the obsolete keyphrases, the universal keyphrases, the trend keyphrases, and the undefined keyphrases. That is, the extraction device 100 evaluates the content. In the example illustrated in FIG. 18, “important failure notice” is classified into the user dictionary keyphrases, “supported OS” is classified into the undefined keyphrases, and “Windows 95” is classified into the obsolete keyphrases. In addition, “Windows 98” is classified into the undefined keyphrases, and “Windows 8” is classified into the trend keyphrases.

Next, the extraction device 100 sets the content H-1 as to-be-evaluated content and sets the pieces of content D-1 to G-1, I-1, and J-1 as keyphrase extraction source content.

The extraction device 100 classifies the pieces of content D-1 to F-1 into the first group (in which the number of accesses is small). The extraction device 100 classifies the pieces of content G-1, I-1, and J-1 into the second group (in which the number of accesses is large). The extraction device 100 extracts keyphrases for each of the first group and the second group.

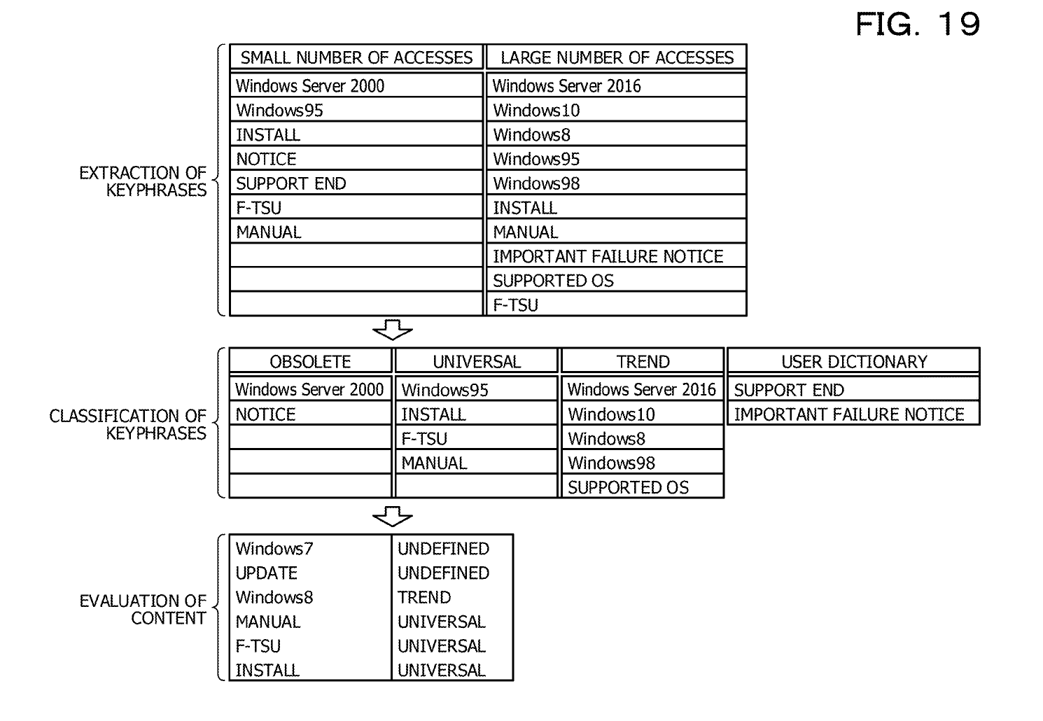

FIG. 19 illustrates an example of extraction and classification of keyphrases when the content H-1 is evaluated. FIG. 19 illustrates keyphrases classified into the group (the first group) in which the number of accesses is small and the group (the second group) in which the number of accesses is large when the content H-1 is evaluated.

The extraction device 100 classifies the keyphrases in the first group and the second group into the obsolete keyphrases, the universal keyphrases, and the trend keyphrases. The extraction device 100 classifies each keyphrase extracted from the content H-1, which is to-be-evaluated content, into one of the user dictionary keyphrases, the obsolete keyphrases, the universal keyphrases, the trend keyphrases, and the undefined keyphrases. That is, the extraction device 100 evaluates the content. In the example illustrated in FIG. 19, “Windows 7” and “update” are classified into the undefined keyphrases, “Windows 8” is classified into the trend keyphrases, and “manual”, “F-tsu”, and “install” are classified into the universal keyphrases.

Next, the extraction device 100 sets the content I-1 as to-be-evaluated content and sets the pieces of content D-1 to H-1 and J-1 as keyphrase extraction source content.

The extraction device 100 classifies the pieces of content D-1 to F-1 into the first group (in which the number of accesses is small). Also, the extraction device 100 classifies the pieces of content G-1, H-1, and J-1 into the second group (in which the number of accesses is large). The extraction device 100 extracts keyphrases for each of the first group and the second group.

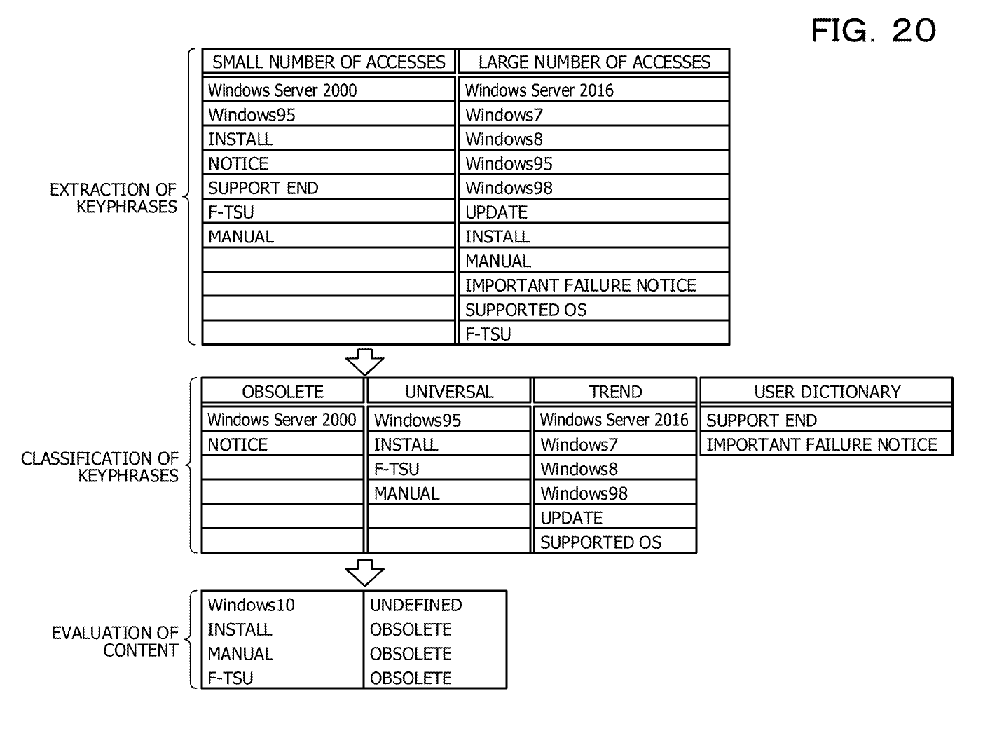

FIG. 20 illustrates an example of extraction and classification of keyphrases when the content I-1 is evaluated. FIG. 20 illustrates keyphrases classified into the group (the first group) in which the number of accesses is small and the group (the second group) in which the number of accesses is large when the content I-1 is evaluated.

The extraction device 100 classifies the keyphrases in the first group and the second group into the obsolete keyphrases, the universal keyphrases, and the trend keyphrases. The extraction device 100 classifies each keyphrase extracted from the content I-1, which is to-be-evaluated content, into one of the user dictionary keyphrases, the obsolete keyphrases, the universal keyphrases, the trend keyphrases, and the undefined keyphrases. That is, the extraction device 100 evaluates the content. In the example illustrated in FIG. 20, “Windows 10” is classified into the undefined keyphrases, and “install”, “manual”, and “F-tsu” are classified into the universal keyphrases.

Next, the extraction device 100 sets the content J-1 as to-be-evaluated content and sets the pieces of content D-1 to I-1 as keyphrase extraction source content.

The extraction device 100 classifies the pieces of content D-1 to F-1 into the first group (in which the number of accesses is small). Also, the extraction device 100 classifies the pieces of content G-1 to I-1 into the second group (in which the number of accesses is large). The extraction device 100 extracts keyphrases for each of the first group and the second group.

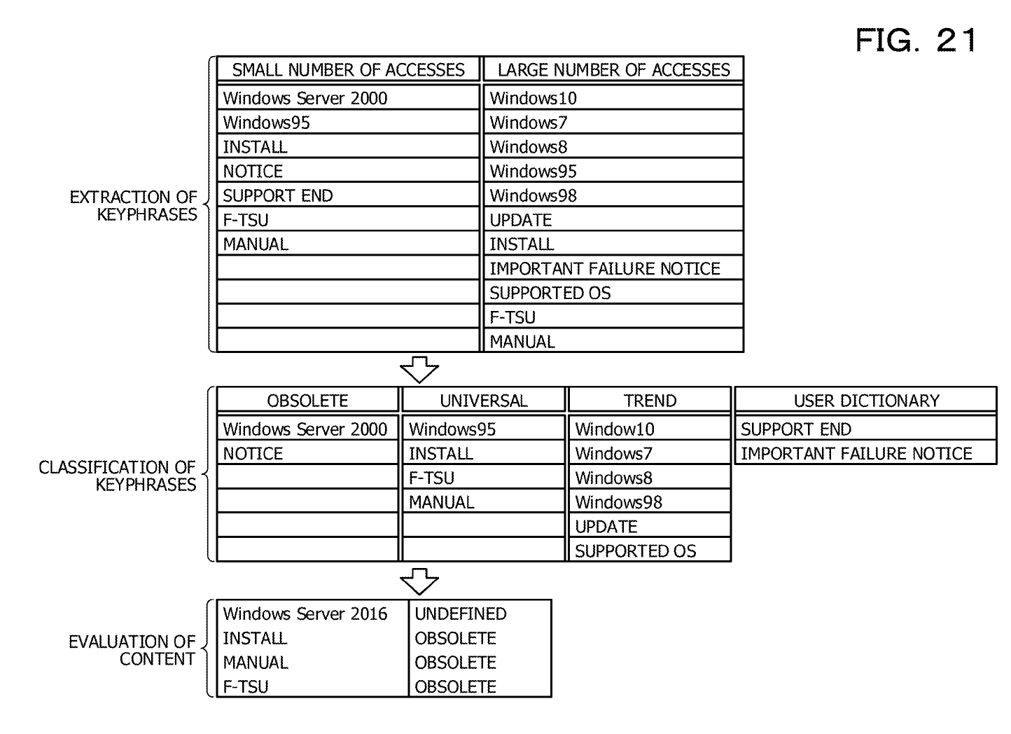

FIG. 21 illustrates an example of extraction and classification of keyphrases when the content J-1 is evaluated. FIG. 21 illustrates keyphrases classified into the group (the first group) in which the number of accesses is small and the group (the second group) in which the number of accesses is large when the content J-1 is evaluated.

The extraction device 100 classifies the keyphrases in the first group and the second group into the obsolete keyphrases, the universal keyphrases, and the trend keyphrases. The extraction device 100 classifies each keyphrase extracted from the content J-1, which is to-be-evaluated content, into one of the user dictionary keyphrases, the obsolete keyphrases, the universal keyphrases, the trend keyphrases, and the undefined keyphrases. That is, the extraction device 100 evaluates the content. In the example illustrated in FIG. 21, “Windows Server 2016” is classified into the undefined keyphrases, and “install”, “manual”, and “F-tsu” are classified into the universal keyphrases.

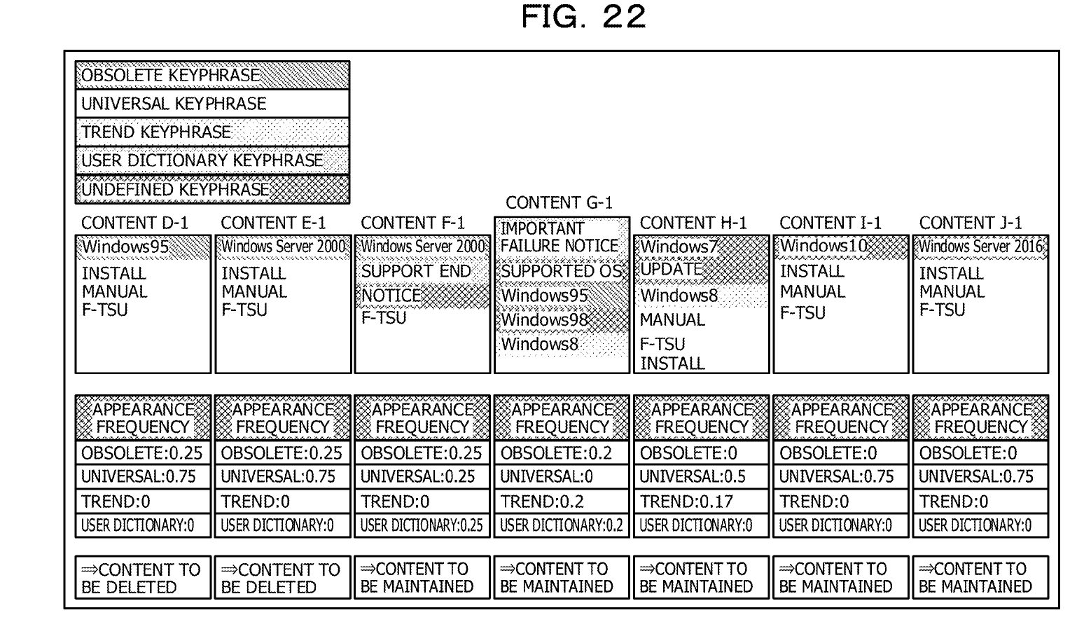

FIG. 22 illustrates an example of evaluation results of the content. FIG. 22 illustrates a summary of evaluation results of the content illustrated in FIGS. 15 to 21. Also, FIG. 22 illustrates appearance frequencies, that is, appearance rates, of the respective classifications of the keyphrases in each piece of content. The extraction device 100 compares the appearance frequencies with the deletion conditions to determine whether or not each piece of content is to be deleted or to be maintained. In the example illustrated in FIG. 22, appearance frequencies “obsolete: 0.2 or more, universal: 0.8 or less, trend: 0, and user dictionary: 0″ are used as the deletion conditions.

For the content D-1, the appearance frequency of obsolete keyphrases is “0.25”, the appearance frequency of universal keyphrases is “0.75”, the appearance frequency of trend keyphrases is “0”, and the appearance frequency of user dictionary keyphrases is “0”. Accordingly, the content D-1 satisfies the deletion conditions and is thus content to be deleted.

For the content E-1, the appearance frequency of obsolete keyphrases is “0.25”, the appearance frequency of universal keyphrases is “0.75”, the appearance frequency of trend keyphrases is “0”, and the appearance frequency of user dictionary keyphrases is “0”. Accordingly, the content E-1 satisfies the deletion conditions and is thus content to be deleted.

For the content F-1, the appearance frequency of obsolete keyphrases is “0.25”, the appearance frequency of universal keyphrases is “0.25”, the appearance frequency of trend keyphrases is “0”, and the appearance frequency of user dictionary keyphrases is “0.25”. Accordingly, the content F-1 does not satisfy the deletion conditions and is thus content to be maintained.

For the content G-1, the appearance frequency of obsolete keyphrases is “0.2”, the appearance frequency of universal keyphrases is “0”, the appearance frequency of trend keyphrases is “0.2”, and the appearance frequency of user dictionary keyphrases is “0.2”. Accordingly, the content G-1 does not satisfy the deletion conditions and is thus content to be maintained.

For the content H-1, the appearance frequency of obsolete keyphrases is “0”, the appearance frequency of universal keyphrases is “0.5”, the appearance frequency of trend keyphrases is “0.17”, and the appearance frequency of user dictionary keyphrases is “0”. Accordingly, the content H-1 does not satisfy the deletion conditions and is thus content to be maintained.

For the content I-1, the appearance frequency of obsolete keyphrases is “0”, the appearance frequency of universal keyphrases is “0.75”, the appearance frequency of trend keyphrases is “0”, and the appearance frequency of user dictionary keyphrases is “0”. Accordingly, the content I-1 does not satisfy the deletion conditions and is thus content to be maintained.

For the content J-1, the appearance frequency of obsolete keyphrases is “0”, the appearance frequency of universal keyphrases is “0.75”, the appearance frequency of trend keyphrases is “0”, and the appearance frequency of user dictionary keyphrases is “0”. Accordingly, the content J-1 does not satisfy the deletion conditions and is thus content to be maintained.

As described above, evaluation results of the pieces of content D-1 to J-1 are that the pieces of content D-1 and E-1 are content to be deleted and the pieces of content F-1 to J-1 are content to be maintained. For example, although the number of accesses to the content F-1 to be maintained is “5”, which is the same as the number of accesses to the content E-1 to be deleted, the content F-1 does not satisfy the deletion conditions and is thus to be maintained, since it includes a user dictionary keyphrase. That is, it is possible for the extraction device 100 to extract content that is likely to be referred to in the future, even if the reference count of the content is small. That is, in the extraction device 100, the number of accesses being small does not directly become a deletion condition, and evaluation is performed through comparison with content in other sites. Thus, content to which the number of accesses is small is not simply deleted.

As described above, the extraction device 100 obtains reference counts that are the numbers of times respective pieces of content were referred to. Based on the reference counts, the extraction device 100 classifies the pieces of content into a plurality of groups. The extraction device 100 extracts main phrases of the content from each of the groups, the main phrases being based on the appearance frequencies of words included in the content. The extraction device 100 extracts the content including a main phrase that appears in all of the groups. As a result, the extraction device 100 can extract content that is likely to be referred to in the future, even if the reference count of the content is small. The extraction device 100 can also reduce the amount of search load during search for content that is likely to be referred to in the future.

Also, the extraction device 100 classifies pieces of content different from to-be-evaluated content into a plurality of groups. When the to-be-evaluated content includes a main phrase that appears in all of the groups, the extraction device 100 extracts the to-be-evaluated content. As a result, the extraction device 100 extracts more appropriate keyphrases.

The extraction device 100 also classifies pieces of content into a first group in which the reference count is small and a second group in which the reference count is large. This allows the extraction device 100 to extract universal keyphrases with respect to the reference counts.

The extraction device 100 also classifies the main phrases extracted from each of the groups into the first main phrases that appear in only the first group, the second main phrases that appear in both of the first and second groups, and the third main phrases that appear in only the second group. The extraction device 100 also extracts content, based on the appearance frequencies of the first main phrases, the second main phrases, and the third main phrases. This allows the extraction device 100 to extract content by using keyphrases according to the reference counts.

Also, the extraction device 100 stores, in the undefined-keyphrase storage section 122, a fourth main phrase that is included in the main phrases extracted from the to-be-evaluated content and that is a main phrase not corresponding to any of the first main phrases, the second main phrases, and the third main phrases. During next content extraction, when a fourth main phrase extracted from the to-be-evaluated content matches any of the fourth main phrases stored in the undefined-keyphrase storage section 122, the extraction device 100 classifies the extracted fourth main phrase into the first main phrases. This allows the extraction device 100 to classify a keyphrase that appears in only the to-be-evaluated content into the obsolete keyphrases.

Also, by referring to the user-dictionary storage section 123 in which pre-set fifth main phrases are stored and based on the appearance frequencies of the first main phrases, the second main phrases, the third main phrases, and the fifth main phrases, the extraction device 100 extracts content. This allows the extraction device 100 to inhibit mistakenly deleting content, by designating a keyphrase included in content desired to be maintained.

In other words, the extraction device 100 updates the appearance frequency setting values for extracting content, based on the appearance frequencies of the first main phrases, the second main phrases, the third main phrases, and the fifth main phrases in content that is included in pieces of content and that was not extracted. This allows the extraction device 100 to more appropriately extract content that is desired to be maintained.

Also, when a first main phrase included in content that was not extracted is included in the user-dictionary storage section 123 in which the fifth main phrases are stored, the extraction device 100 deletes the fifth main phrase that matches the first main phrase from the user-dictionary storage section 123 in which the fifth main phrases are stored. As a result, the extraction device 100 can delete an obsolete keyphrase from the user dictionary.

The extraction device 100 also stores a third main phrase, included in the extracted content, in the user-dictionary storage section 123 in which the fifth main phrases are stored as a fifth main phrase to be added. This allows the extraction device 100 to register a trend keyphrase in the user dictionary.

The extraction device 100 also issues, to a source from which the reference counts of the pieces of content were obtained, an instruction for deleting the to-be-evaluated content that is included in to-be-evaluated content not extracted and that satisfies a predetermined condition. This allows the extraction device 100 to delete obsolete content from the web server 10.

In the above-described embodiment, when a predetermined number of days has passed from the last update date of deletion candidate content, the deletion information is transmitted to the corresponding web server 10 to delete the deletion candidate content, but the present disclosure is not limited thereto. For example, the deletion information may be transmitted to a terminal apparatus (not illustrated) used by the administrator of the corresponding web server 10, and after obtaining approval from the administrator, the web server 10 may delete the deletion candidate content.

Although, in the above-described embodiment, all content in a site of interest is evaluated, the present disclosure is not limited thereto. For example, if subordinate content linked from certain content does not have a link from other superordinate content, the subordinate content may be deleted together with content in a source of the link.

Also, although, in the above-described embodiment, keyphrase extraction source content is classified into the two groups, the present disclosure is not limited thereto. For example, keyphrase extraction source content may be classified into three or more groups in accordance with the number of accesses to the content.

Although, in the above-described embodiment, the number of accesses (reference count) is obtained based on the access log of each piece of content in the web server 10, the present disclosure is not limited. For example, an access counter may be provided for each piece of content to aggregate the number of accesses.

The constituent elements of the illustrated units and portions may or may not be physically configured as illustrated. That is, specific forms of distribution/integration of the units and portions are not limited to those illustrated, and all or some thereof may be functionally or physically distributed or integrated in an arbitrary manner, depending on various loads, usage states, and so on. For example, the second extractor 135 may be configured as a functional unit from which the deletion processing is separated. The illustrated processes are not limited to the above-described order. For example, the processes may be performed at the same time, or the order of the processes may be interchanged for execution, as long as such a change does not cause contradiction in details of processing.

In addition, all or any of the processing functions of each apparatus may also be executed by a CPU (or a microcomputer, such as an MPU or a micro controller unit (MCU)). Needless to say, all or any of the processing functions may also be executed on a program analyzed and executed by a CPU (or a microcomputer, such as an MPU or MCU) or on wired-logic-based hardware.

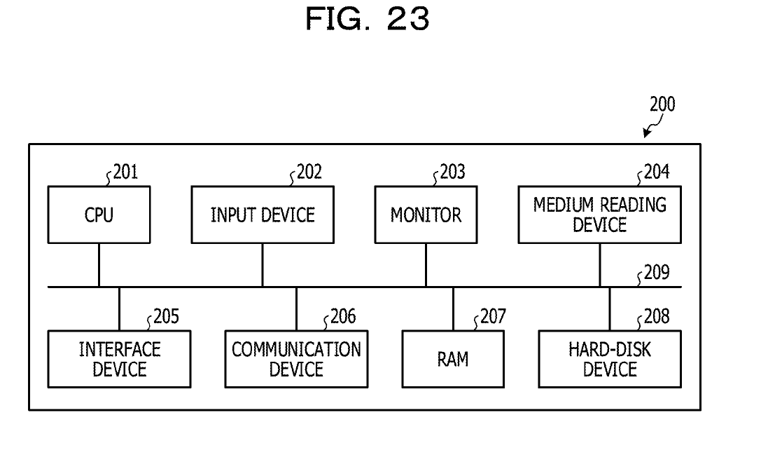

The various types of processing described in the above embodiment may be realized by executing a prepared program with a computer. Accordingly, a description below will be given of an example of a computer that executes a program having functions that are analogous to those in the above-described embodiment. FIG. 23 is a block diagram illustrating an example of a computer that executes an extraction program.

As illustrated in FIG. 23, a computer 200 includes a CPU 201 that executes various computational processing, an input device 202 that receives a data input, and a monitor 203. The computer 200 further includes a medium reading device 204 that reads a program or the like from a storage medium, an interface device 205 for connecting to various apparatuses and devices, and a communication device 206 for performing wired or wireless connection with another information processing apparatus or the like. The computer 200 further includes a RAM 207 for temporary storing various types of information and a hard-disk device 208. The devices 201 to 208 are also connected to a bus 209.

An extraction program having functions that are the same as or similar to those of the processing units, that is, the obtainment unit 131, the first classifier 132, the first extractor 133, the second classifier 134, the second extractor 135, and the updater 136, illustrated in FIG. 1, are stored in the hard-disk device 208. The keyphrase storage section 121, the undefined-keyphrase storage section 122, the user-dictionary storage section 123, the deletion-candidate storage section 124, the condition storage section 125, and various types of data for realizing the extraction program are stored in the hard-disk device 208. The input device 202 receives, for example, an input of various types of information, such as operational information, from an administrator of the computer 200. The monitor 203 displays, for example, various screens, such as a display screen, to the administrator of the computer 200. For example, a printer or the like is connected to the interface device 205. The communication device 206 has, for example, functions that are the same as or similar to those of the communication unit 110 illustrated in FIG. 1 and is connected to the network N to transmit/receive various types of information to/from the web server 10, another information processing apparatus, or the like.

The CPU 201 reads programs stored in the hard-disk device 208, loads the programs into the RAM 207, and executes the programs to thereby perform various types of processing. These programs also allow the computer 200 to function as the obtainment unit 131, the first classifier 132, the first extractor 133, the second classifier 134, the second extractor 135, and the updater 136 illustrated in FIG. 1.

The above-described extraction program may or may not be stored in the hard-disk device 208. For example, the computer 200 may read and execute the program stored on/in a storage medium that is readable by the computer 200. Examples of the storage medium that is readable by the computer 200 include portable recording media, such as a compact disc read-only memory (CD-ROM) a digital versatile disc (DVD), and a Universal Serial Bus (USB) memory, a semiconductor memory, such as a flash memory, and a hard-disk drive. The extraction program may be stored in a device connected to a public line, the Internet, a LAN, or the like, and the computer 200 may read therefrom and execute the extraction program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
obtaining reference counts that are numbers of times respective pieces of content were referred to;
classifying the pieces of content into a plurality of groups based on the reference counts;
selecting one or more feature phrases from each of the pieces of content based on appearance frequencies of words included in each of the pieces of content; and
extracting first content that includes a feature phrase which is included in all of the plurality of groups, wherein the feature phrase is any one of the one or more features selected by the selecting.

2. The non-transitory computer-readable storage medium according to claim 1, wherein
the classifying classifies the pieces of content other than the first content; wherein
the extracting extracts the first content when first content includes the first feature phrase.

3. The non-transitory computer-readable storage medium according to claim 2, wherein
the classifying classifies the pieces of content into a first group and a second group, the reference counts of content in the first group is smaller than the reference counts of content in the second group.

4. The non-transitory computer-readable storage medium according to claim 3, wherein the process further comprises:
classifying the one or more feature phrases into a plurality of phrase groups including a first phrase group that appear in only the first group in the plurality of groups, a second phrase group that appear in both the first group and the second group, and third phrase group that appear in only the second group in the plurality of groups; and wherein the extracting extracts the first content based on appearance frequencies of the first phrase group, the second phrase group, and the third phrase group.

5. The non-transitory computer-readable storage medium according to claim 4, wherein
the plurality of groups further includes a fourth phrase group including one or more feature phrases that appear only in the first content in the pieces of content; and
when a second feature phrase included in the fourth phrase group is extracted from a second content for which the selecting is performed after the selecting for the first content, move the second feature phrase from the fourth phrase group to the first phrase group.

6. The non-transitory computer-readable storage medium according to claim 4, wherein
the extracting the first content is performed further based on a fifth phrase group including feature phrases determined in advance.

7. The non-transitory computer-readable storage medium according to claim 6, wherein the process further comprises:
updating setting values of the respective appearance frequencies for extracting the content, based on the appearance frequencies of the first phrase group, the second phrase group, the third phrase group, and the fifth phrase group in the content that is included in the pieces of content.

8. The non-transitory computer-readable storage medium according to claim 7, wherein
the updating includes deleting a third feature phrase included in the fifth phrase group when the third feature phrase is also included in the first phrase group.

9. The non-transitory computer-readable storage medium according to claim 7, wherein
the updating includes classifying a fourth feature phrase, included in the third phrase group and included in the first content, into the fifth phrase group.

10. The non-transitory computer-readable storage medium according to claim 2, wherein the process further comprises:
deleting a content, included in the pieces of content, that satisfies a predetermined condition.

11. An extraction method executed by a computer, the extraction method comprising:
obtaining reference counts that are numbers of times respective pieces of content were referred to;
classifying the pieces of content into a plurality of groups based on the reference counts;
selecting one or more feature phrases from each of the pieces of content based on appearance frequencies of words included in each of the pieces of content; and
extracting first content that includes a feature phrase which is included in all of the plurality of groups, wherein the feature phrase is any one of the one or more features selected by the selecting.

12. An extraction device comprising:
a memory; and
a processor coupled to the memory and the processor configured to execute a process, the process including:
obtaining reference counts that are numbers of times respective pieces of content were referred to;
classifying the pieces of content into a plurality of groups based on the reference counts;
selecting one or more feature phrases from each of the pieces of content based on appearance frequencies of words included in each of the pieces of content; and
extracting first content that includes a feature phrase which is included in all of the plurality of groups, wherein the feature phrase is any one of the one or more features selected by the selecting.
